(19) United States
(12) Patent Application Publication
(10) Pub. No.: US 2019/0242141 A1
(43) Pub. Date: Aug. 8, 2019

(54) CORNER TRIM MOUNTING SYSTEM

(71) Applicant: James Hardie Technology Limited, Dublin (IE)

(72) Inventors: Thayne Dye, Upland, CA (US); Matthew Spencer, Palatine, IL (US)

(21) Appl. No.: 16/267,026

(22) Filed: Feb. 4, 2019

Related U.S. Application Data
(60) Provisional application No. 62/626,368, filed on Feb. 5, 2018.

(51) Int. Cl. E04F 19/06; F16B 15/00

(52) U.S. Cl. CPC E04F 19/061; F16B 15/0046; E04F 19/064

(57) ABSTRACT

A corner trim mounting system includes a corner trim fastening bracket having a first arm and a second arm joined at an angle. Each arm includes a plurality of inward-facing outer teeth configured to couple the fastening bracket to a building substrate at an outer corner, and a plurality of outward-facing inner teeth configured to receive trim boards so as to retain the trim boards to form a corner trim. The two sets of inner teeth can be parallel such that the fastening bracket can be driven into two perpendicular trim boards simultaneously. A complementary pressing assembly, including a trim support and a bracket driver, may be provided to facilitate assembly of corner trim using the fastening bracket.

### CROSS-REFERENCE TO RELATED APPLICATIONS

This application claims the benefit of U.S. Provisional Application Ser. No. 62/626,368, filed Feb. 5, 2018, entitled “CORNER TRIM MOUNTING SYSTEM,” which is hereby incorporated by reference in its entirety and for all purposes.

### BACKGROUND

### Field

The present disclosure generally relates to construction, and more specifically to trim mounting systems and methods.

### Description of the Related Art

Trim components, such as trim boards, and the like, may be applied to an exterior of a building. One-piece corner trim applications have been developed for application to exterior corners. However, existing one-piece corner trim products generally require a mechanical fastener which must be installed in the field using a fastening tool, such as a nail gun, a driver, or the like. Other methods of applying a corner trim, such as separately attaching two or more trim boards, may be cumbersome and imprecise.

### SUMMARY

The systems, methods, and devices described herein address one or more problems as described above and associated with current trim mounting systems. The systems, methods and devices described herein have innovative aspects, no single one of which is indispensable or solely responsible for their desirable attributes. Without limiting the scope of the claims, the summary below describes some of the advantageous features.

In one embodiment, a corner trim system is described. The corner trim system comprises a building substrate comprising a first side and a second side disposed at an angle to the first side at an exterior corner, a corner trim fastening bracket, a first trim board, and a second trim board. The corner trim fastening bracket comprises a substantially planar first arm having a first end and a second end, the first arm comprising an inner portion proximate the first end and an outer portion proximate the second end, the first arm lying adjacent to the building substrate such that the first end is proximate the exterior corner; and a substantially planar second arm having a first end and a second end, the second arm comprising an inner portion proximate the first end and an outer portion proximate the second end, the first end of the second arm being integrally formed with the first end of the first arm such that the second arm lies adjacent to the building substrate. The first arm and the second arm each comprise a plurality of outer teeth extending from the outer portion into the building substrate at an angle greater than or equal to 85° relative to the building substrate, and a plurality of inner teeth extending from the inner portion opposite the building substrate and toward the first end at an angle between 40° and 50° relative to the surface of the inner portion. The first trim board comprises an inner surface, wherein the inner teeth of the first arm extend through the inner surface to retain the first trim board parallel to the first side of the building substrate. The second trim board comprises an inner surface, wherein the inner teeth of the second arm extend through the inner surface to retain the second trim board parallel to the second side of the building substrate.

In some embodiments, a plurality of vertically spaced corner trim fastening brackets are disposed between the building substrate and the first and second trim boards to retain the first and second trim boards to the building substrate.

In some embodiments, the first arm and the second arm each comprise at least four outer teeth and at least eight inner teeth.

In some embodiments, the first arm and the second arm each comprise at least four outer teeth disposed in a cruciform configuration.

In some embodiments, the inner teeth have a length of approximately 0.375 inches, wherein the inner teeth are disposed in a plurality of rows spaced apart by approximately 0.5 inches, and wherein the density of the inner teeth is at least 4.8 teeth per square inch.

In some embodiments, the corner trim fastening bracket comprises steel.

In some embodiments, the first trim board and the second trim board comprise fiber cement.

In another embodiment, a corner trim fastening bracket is described. The corner trim fastening bracket comprises a substantially planar first arm having a first end and a second end, the first arm comprising an inner portion proximate the first end and an outer portion proximate the second end; and a substantially planar second arm having a first end and a second end, the second arm comprising an inner portion proximate the first end and an outer portion proximate the second end, the first end of the second arm being integrally formed with the first end of the first arm such that the second arm extends perpendicularly from the first arm within a plane perpendicular to the first arm. The first arm and the second arm each comprise a plurality of outer teeth extending from the outer portion into a space generally defined by an interior angle between the first arm and the second arm, the outer teeth disposed at an angle greater than or equal to 85° relative to the surface of the outer portion, the outer teeth configured to be driven into a building substrate to couple the corner trim fastening bracket to the building substrate; and a plurality of inner teeth extending from the inner portion into a space opposite the interior angle, the plurality of inner teeth extending toward the first end at an angle smaller than 90° relative to the surface of the inner portion, the inner teeth configured to be driven into a trim board to couple the corner trim fastening bracket to the trim board. The inner teeth of the first arm are substantially parallel to the inner teeth of the second arm such that the corner trim fastening bracket can be simultaneously coupled to two substantially perpendicular trim boards by exerting a linear force on the corner trim fastening bracket parallel to the inner teeth.

In some embodiments, the inner teeth of the first arm and the inner teeth of the second arm lie parallel to a bisection of the interior angle between the first arm and the second arm.

In some embodiments, the first arm and the second arm each comprise a widthwise perforation configured to enable at least the outer portion to be separated from the corner trim fastening bracket.

In some embodiments, the first arm and the second arm each comprise a plurality of widthwise perforations.

In some embodiments, the first arm and the second arm each comprise a widthwise perforation configured to enable separation of a portion of the arm comprising less than all of the outer teeth.

In some embodiments, the first arm and the second arm comprise steel.

In some embodiments, the first arm and the second arm each comprise at least 4 outer teeth.

In some embodiments, the first arm and the second arm each comprise at least 8 inner teeth.

In some embodiments, the first arm and the second arm each have a width between 1 inch and 3 inches, and a length between 5 inches and 7 inches.

In some embodiments, each of the inner teeth and the outer teeth has a length between 0.3 inches and 0.6 inches.

In some embodiments, the corner trim fastening bracket further comprises a reinforcing structure coupled to the first arm and the second arm within the interior angle and configured to prevent deformation of the corner trim fastening bracket.

In some embodiments, each inner tooth of the plurality of inner teeth extends from the first arm or the second arm adjacent to a corresponding inner tooth aperture having a size and shape substantially the same as a size and shape of the inner tooth.

In some embodiments, each outer tooth of the plurality of outer teeth extends from the first arm or the second arm adjacent to a corresponding outer tooth aperture having a size and shape substantially the same as a size and shape of the outer tooth.

In another embodiment, a method of assembling a corner trim is described. The method comprises obtaining a first trim board comprising an inner surface, obtaining a second trim board comprising an inner surface, and obtaining a fastening bracket, the fastening bracket comprising a substantially planar first arm having a first end and a second end, the first arm comprising an inner portion proximate the first end and an outer portion proximate the second end; and a substantially planar second arm having a first end and a second end, the second arm comprising an inner portion proximate the first end and an outer portion proximate the second end, the first end of the second arm being contiguous with the first end of the first arm such that the second arm extends perpendicularly from the first arm within a plane perpendicular to the first arm. The first arm and the second arm each comprise a plurality of outer teeth extending from the outer portion into a space generally defined by an interior angle between the first arm and the second arm, the outer teeth disposed at an angle greater than or equal to 85° relative to the surface of the outer portion, the outer teeth configured to be driven into a building substrate to couple the corner trim fastening bracket to the building substrate; and a plurality of inner teeth extending from the inner portion into a space opposite the interior angle, the plurality of inner teeth extending toward the first end at an angle between 40° and 50° relative to the surface of the inner portion, the inner teeth configured to be driven into a trim board to couple the corner trim fastening bracket to the trim board. The method further comprises simultaneously fixing the first trim board to the first arm and fixing the second trim board to the second arm to form a one-piece corner trim.

In some embodiments, the method further comprises placing the corner trim against a building substrate comprising a first side and a second side perpendicular to the first side at an exterior corner, such that the exterior corner of the building substrate seats within the interior angle of the fastening bracket; driving the outer teeth of the first arm into the first side of the building substrate by applying a linear force parallel to the outer teeth of the first arm; and driving the outer teeth of the second arm into the second side of the building substrate by applying a linear force parallel to the outer teeth of the second arm, such that the one-piece corner trim is affixed to the building substrate.

In some embodiments, the method further comprises obtaining a second fastening bracket, and simultaneously fixing the first trim board to a first arm of the second fastening bracket and fixing the second trim board to a second arm of the second fastening bracket.

In some embodiments, fixing the first trim board to the first arm and fixing the second trim board to the second arm to form a one-piece corner trim comprises placing the first trim board into a substantially V-shaped trough of a trim support device, placing the second trim board into the trough perpendicular to the first trim board, placing the fastening bracket into the trough such that the inner teeth of the fastening bracket rest against the first and second trim boards, placing a bracket driver onto the fastening bracket such that a pressing head of the bracket driver seats within the interior angle of the fastening bracket, and applying a downward force to the bracket driver to drive the inner teeth into the first and second trim boards.

In some embodiments, the downward force is applied by at least one of a mechanical press or a hammer.

In some embodiments, the first arm and the second arm each comprise a widthwise perforation, the method further comprising separating at least the outer portion of the first arm and the second arm from the corner trim fastening bracket at the perforations.

In another embodiment, a corner trim assembly system is described. The corner trim assembly system comprises a trim support comprising a trough generally defined by a first trough surface and a second trough surface disposed at an angle to the first trough surface at an interior corner, the trough configured to at least partially support a first trim board and a second trim board disposed relative to the first trim board at an angle substantially equal to the angle of the interior corner; and a bracket driver comprising a pressing head generally defined by a first pressing surface and a second pressing surface disposed at an angle to the first pressing surface at an exterior corner, wherein the angle of the exterior corner is substantially equal to the angle of the interior corner of the trough, and a force receiving surface rigidly coupled to the pressing head, at least a portion of the force receiving surface comprising a planar surface perpendicular to an axis bisecting the angle of the exterior corner. The bracket driver is configured to seat within a fastening bracket comprising two arms disposed at an angle substantially equal to the angle of the exterior corner. The bracket driver is configured to substantially uniformly distribute, across the first pressing surface and the second pressing surface, a linear force applied to the force receiving surface.

In some embodiments, the exterior corner of the pressing head comprises a recess sized and shaped to accommodate a reinforcing bar of the fastening bracket.

### BRIEF DESCRIPTION OF THE DRAWINGS

Certain embodiments of the present disclosure will now be described, by way of example only, with reference to the accompanying drawings. From figure to figure, the same or similar reference numerals are used to designate similar components of an illustrated embodiment.

FIGS. 1A and 1B are perspective views of a fastening bracket in accordance with an exemplary embodiment.

FIG. 1C is a top plan view of the fastening bracket of FIGS. 1A and 1B.

FIGS. 1D and 1E are side elevation views of the fastening bracket of FIGS. 1A-1C.

FIGS. 2A and 2B are perspective views of a fastening bracket in accordance with an exemplary embodiment.

FIG. 2C is a top plan view of the fastening bracket of FIGS. 2A and 2B.

FIGS. 2D and 2E are side elevation views of the fastening bracket of FIGS. 2A-2C.

FIG. 3A is an exterior perspective view of an assembled corner trim including fastening brackets.

FIG. 3B is an interior perspective view of the assembled corner trim and fastening brackets of FIG. 3A.

FIG. 3C is a top plan view of the assembled corner trim and fastening brackets of FIGS. 3A and 3B.

FIG. 4A is an exterior perspective view of an assembled corner trim including the medial sections of fastening brackets.

FIG. 4B is an interior perspective view of the assembled corner trim and fastening bracket medial sections of FIG. 4A.

FIG. 4C is a top plan view of the assembled corner trim and fastening bracket medial sections of FIGS. 4A and 4B.

FIG. 5A is a perspective view of fastening brackets affixed to an exterior corner of a building substrate.

FIG. 5B is a perspective view of two trim boards affixed to the fastening brackets of FIG. 5A to form a corner trim mounted on the building substrate.

FIG. 5C is a top plan view of a mounted corner trim and building substrate similar to the configuration of FIG. 5B.

FIGS. 6A and 6B depict a trim support component of a pressing assembly for assembling corner trim.

FIGS. 7A and 7B depict a bracket driver component of the pressing assembly for assembling corner trim.

FIGS. 8A-8E depict an example process of assembling a corner trim using the pressing assembly of FIGS. 6A-7B.

### DETAILED DESCRIPTION

Although the present disclosure is described with reference to specific examples, it will be appreciated by those skilled in the art that the present disclosure may be embodied in many other forms. The embodiments discussed herein are merely illustrative and do not limit the scope of the present disclosure.

In the description which follows, like parts are marked throughout the specification and drawings with the same or similar reference numerals. The drawing figures are not necessarily to scale and certain features may be shown exaggerated in scale or in somewhat generalized or schematic form in the interest of clarity and conciseness.

Generally described, this disclosure provides systems and methods for improved assembly and installation of trim, such as interior or exterior corner trim. Some embodiments include fastening brackets configured to fasten two or more trim boards together to form a one-piece corner trim. The fastening brackets may further be configured to anchor the one-piece corner trim to a building substrate for installation purposes. Some embodiments include a pressing assembly, including a trough and a pressing head, operable to hold two or more trim boards in a desired relative orientation and facilitate fastening of the trim boards in the desired orientation with a fastening bracket.

In some embodiments, the fastening brackets may advantageously be constructed such that a corner trim can be assembled onto the fastening brackets without requiring any tools other than a striking or pressing tool such as a hammer. The fastening brackets may further be configured to allow an assembled trim corner to be installed onto a building substrate without requiring any tools other than a striking or pressing tool such as a hammer. For example, the fastening brackets can include parallel sets of inner teeth oriented such that the longitudinal axis extending through each tooth is substantially parallel to an axis bisecting the angle between the arms of the bracket, such that force applied to the center of the bracket causes the inner teeth to be pushed into adjacent trim boards without bending. Similarly, the fastening brackets can include two sets of outer teeth that are generally oriented perpendicular to their respective arms such that force applied to each arm opposite the outer teeth causes the outer teeth to be pushed into the wall without bending.

In some embodiments, the fastening brackets may be fastenable to trim boards and building substrates by a plurality of teeth to form a structurally robust corner trim piece that is firmly anchored to the building substrate. Teeth or other integrally formed anchoring elements may advantageously enhance the strength of the fastening brackets, as compared with nailing or otherwise fastening the brackets to trim boards, because the mounting members do not extend through the arms. Additionally, the integrally formed anchoring elements described herein may enhance the appearance of installed trim by avoiding any gaps or uneven alignment that can be created by traditional fasteners.

One embodiment includes a bracket having a first arm comprising a plurality of integrally formed mounting members extending outwardly at an angle, and a second plurality of integrally formed mounting members extending inwardly, such that all of the first plurality of mounting members can be driven into one or more trim boards or other structures when a single pressing force is applied to the bracket. Another embodiment includes a bracket having a second arm comprising a plurality of integrally formed mounting members extending outwardly at an angle, and a second plurality of integrally formed mounting members extending inwardly, such that all of the first plurality of mounting members can be driven into one or more trim boards or other structures when a single pressing force is applied to the bracket. Another embodiment includes a bracket having two arms arranged in an orthogonal configuration, a first plurality of integrally formed mounting members extending outwardly at an angle, and a second plurality of integrally formed mounting members extending inwardly at an angle, such that all of the first plurality of mounting members can be driven into one or more trim boards or other structures when a single pressing force is applied to the bracket.

Certain embodiments of the fastening brackets may advantageously include interior angle support bars integrally formed within the interior angle of the bracket to maintain a desired angle between the arms of the fastening bracket. The fastening brackets may further be simply and rapidly manufactured, such as by pressing from sheet metal, or other efficient manufacturing methods, such that a large number of substantially uniform fastening brackets may be produced at relatively low cost.

Although the anchoring elements are frequently depicted and described herein as teeth, it will be appreciated that any of various anchoring element structures may equally be included in the fastening brackets described. Generally, the anchoring elements comprise protrusions extending at an angle from the surface of a fastening bracket. The anchoring elements can be arranged in groups, such as sets of inner and/or outer teeth. Each group of anchoring elements can be parallel (e.g., each anchoring element of the group can extend from the surface at substantially the same angle) such that the group of anchoring elements can be driven into a substrate (e.g., a building substrate, trim board, etc.) by driving along a single axis. In some embodiments, the anchoring elements include features configured to facilitate penetration of substrates and retention of the anchoring elements within the substrate. For example, certain embodiments include anchoring elements generally defined by two edges, wherein one edge of each anchoring element includes an angle such that the two edges meet at a point, allowing the anchoring element to penetrate the surface of a substrate. After mounting, the edges of the anchoring elements and the surfaces therebetween may provide a frictional anchoring force within the substrate aiding retention of the fastening bracket to the substrate.

In some embodiments, the fastening brackets include perforations across one or both arms at a location between the outer teeth and the inner teeth. Advantageously, such perforations may allow the outer portions of the arms, including the outer teeth, to be removed such that the corner trim is fastened by the medial portion of the fastening bracket and can be mounted to a building substrate by other mechanical fasteners, such as nails, screws, or the like. In some embodiments, perforations may be disposed within a set of teeth such that at least two different numbers of teeth may be used in an installation, for example, depending on the size and weight of the trim to be installed, the material of a building substrate to which the trim will be mounted, obstructions on the building substrate near the trim mounting location, or other aspects of the installation. Moreover, a plurality of perforations may be provided on each arm such that several selectable lengths and/or numbers of inner and/or outer teeth are selectable. For example, a bracket with two sets of perforations on each arm can allow an installer to use all of the teeth, a portion of the teeth, or no teeth if the outer portion of the arm is removed entirely.

Accordingly, a trim installer may be able to assemble and install corner trim on-site using only trim boards, fastening brackets, a press set, and a hammer. Alternatively, pre-assembled corner trim may be transported to an installation location and mounted to a building substrate using only a hammer. Thus, the systems and methods described herein may significantly reduce the time, difficulty, weight, complexity, mistakes, and/or manufacturing expense associated with existing corner trim systems, and may allow an installer perform a larger number of trim installations in a given time period.

These and other advantages of various embodiments will be apparent from the description that follows.

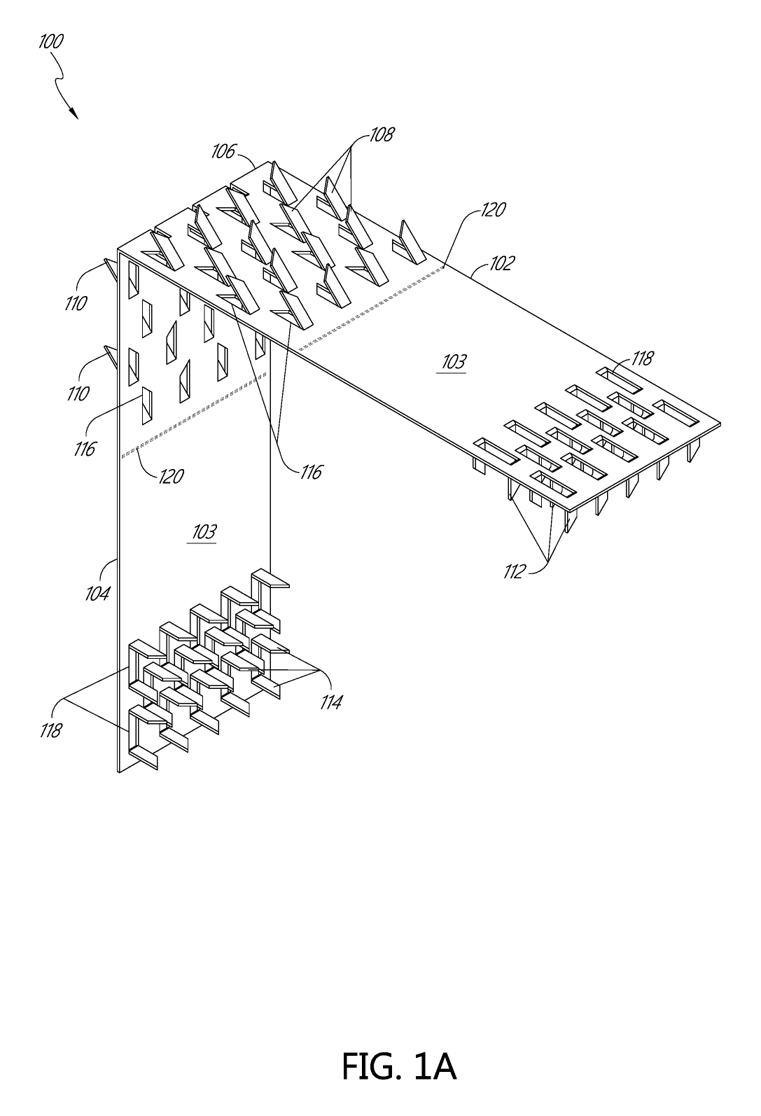

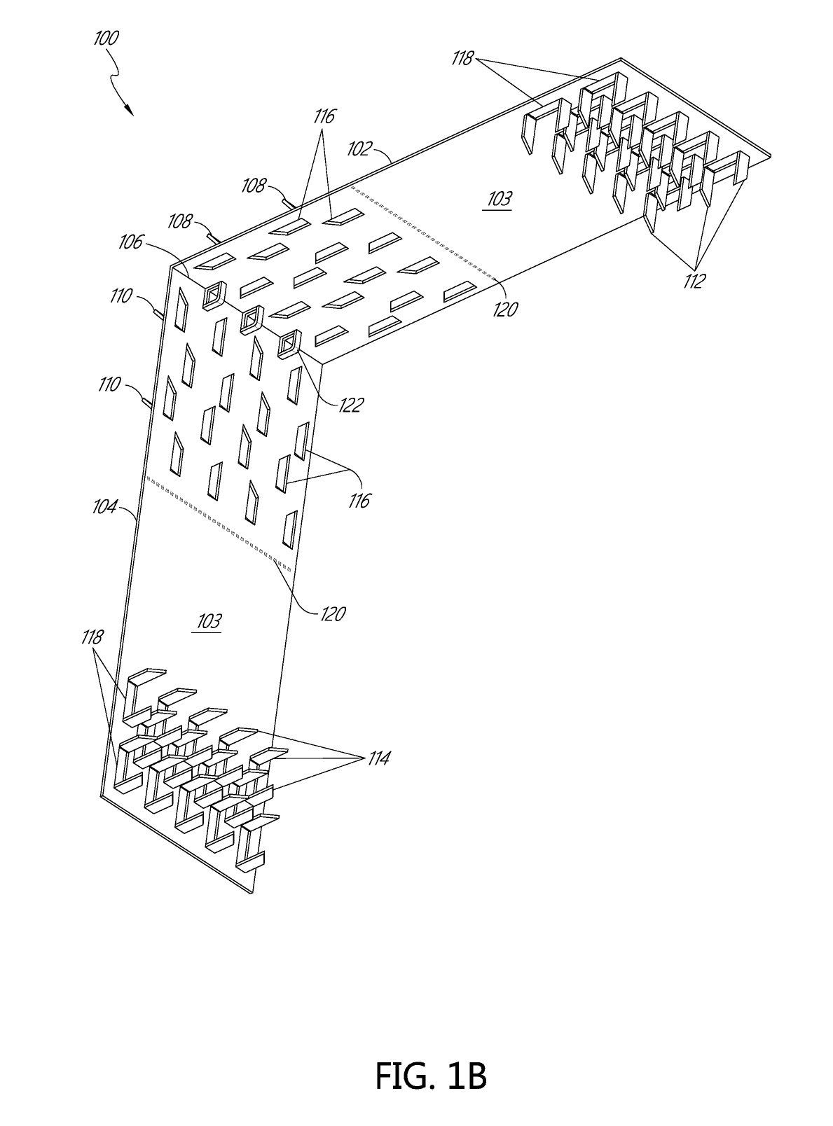

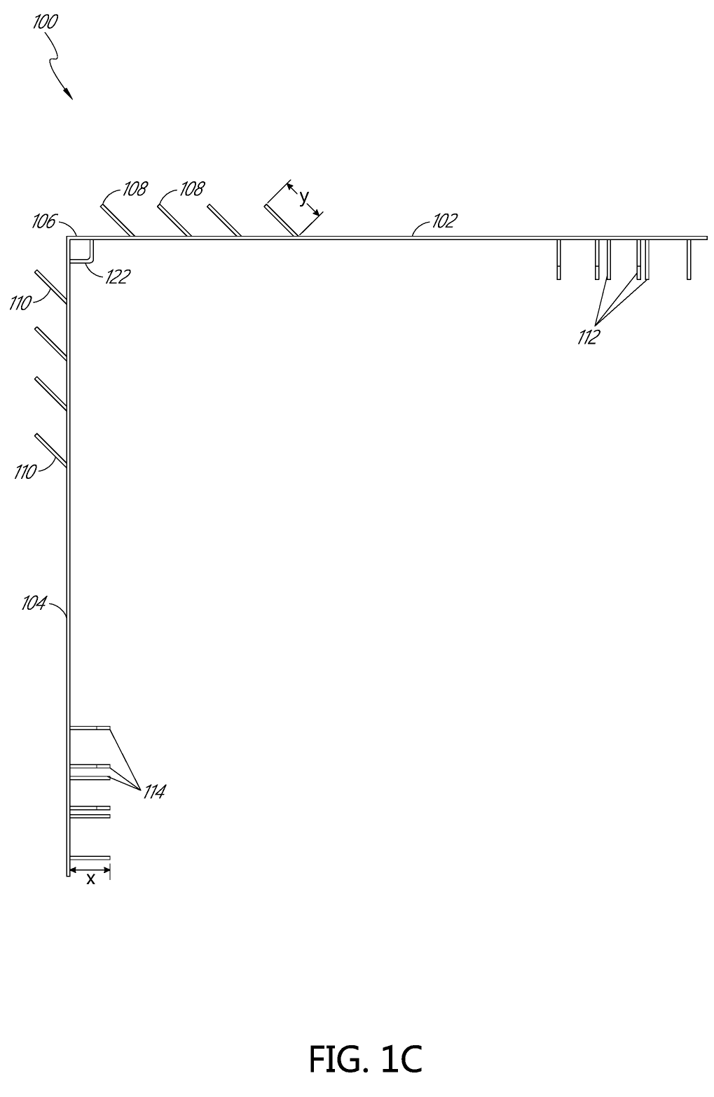

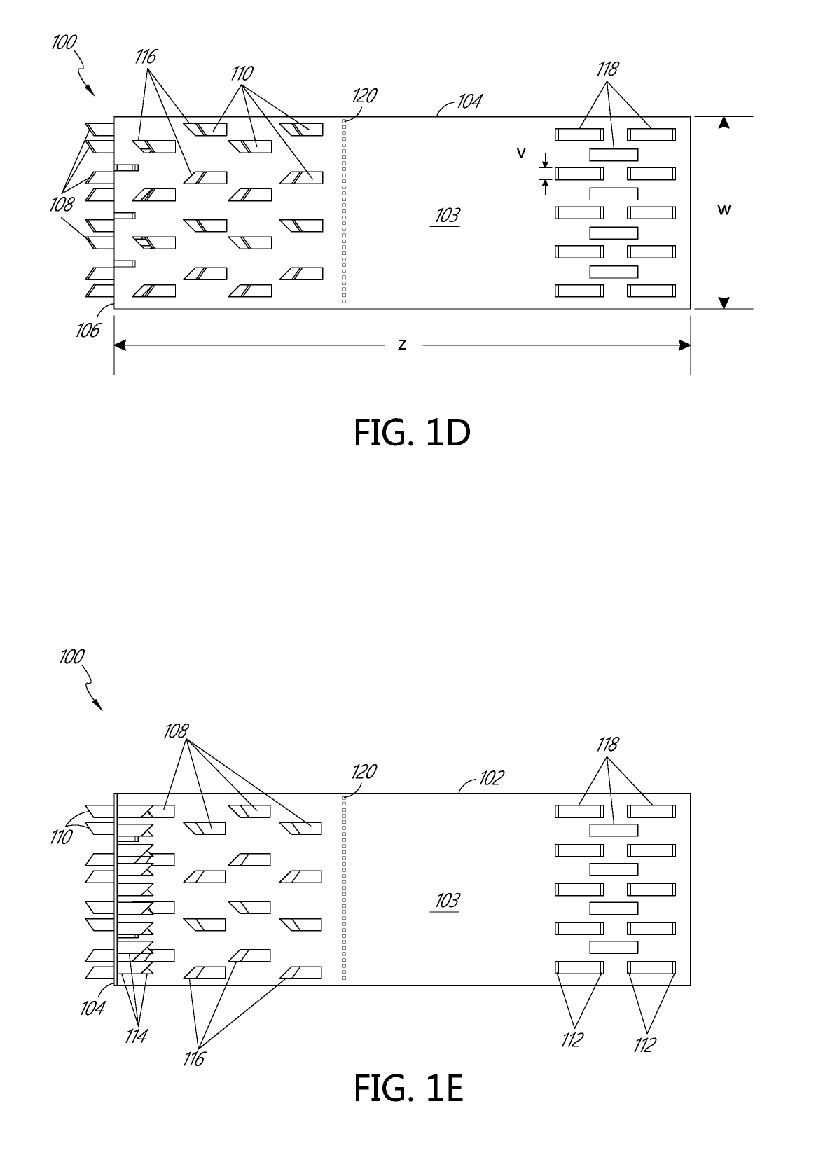

FIGS. 1A-1E depict a fastening bracket 100 in accordance with an exemplary embodiment. The fastening bracket includes a first arm 102 and a second arm 104 abutting and contiguous with the first arm 102 at a corner 106. In some embodiments, the first arm 102 and the second arm 104 comprise a single integrally formed piece of metal or other material. The first arm 102 includes a plurality of inner teeth 108 disposed on an inner portion of the first arm 102 and a plurality of outer teeth 112 disposed on an outer portion of the first arm 102. Similarly, the second arm 104 includes a plurality of inner teeth 110 disposed on an inner portion of the second arm 104 and a plurality of outer teeth 114 disposed on an outer portion of the second arm 104. An intermediate portion 103 of each arm 102, 104 is disposed between the inner teeth 108, 110 and the outer teeth 112, 114. Although the fastening bracket 100 is depicted throughout as being substantially symmetrical about the corner 106, in various embodiments the two arms 102, 104 may differ in characteristics such as length or the location, angle, number, configuration, and/or size of the teeth 108, 110, 112, 114. In the example embodiment of FIGS. 1A-1E, each arm 102, 104 includes 16 inner teeth 108, 110 and 28 outer teeth 112, 114. In some embodiments, the portion of the fastening bracket 100 comprising the inner teeth 108, 110 can include 12 or more teeth in each 2.5-square-inch region (e.g., an average of at least 4.8 teeth per square inch). In some embodiments, the inner teeth 108, 110 can be disposed in rows, each row spaced from adjacent rows by a distance such as 0.5 inches, 0.7 inches, 1 inch, etc. The number of outer teeth 112, 114 may be, for example, between 1 and 28, between 2 and 20, or another range. For example, a relatively large number of outer teeth (e.g., more than 28, etc.) may hinder installation of the outer teeth to a building substrate. In some embodiments, the fastening bracket 100 may include other mounting members instead of or in addition to the teeth described and depicted herein, for example, integrally formed projections, spikes, non-integrally formed projections, or the like.

The outer teeth 112, 114 extend generally perpendicular to the corresponding arm 102, 104. For example, the angle between the outer teeth 112, 114 and the corresponding arm 102, 104 can be approximately 90°. In some embodiments, the angle can be within a range such as between 85° and 95°, between 88° and 92°, between 89° and 91°, etc. Thus, outer teeth 112 are generally perpendicular to outer teeth 114, such that the two sets of outer teeth 112, 114 can be anchored about a building corner of approximately 90°.

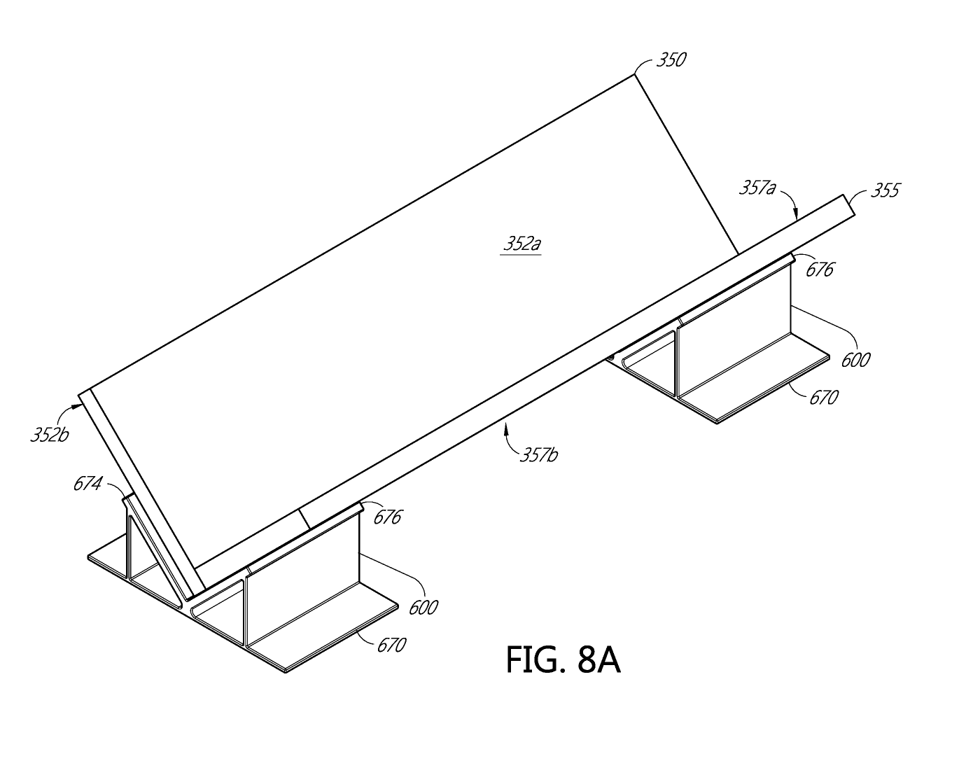

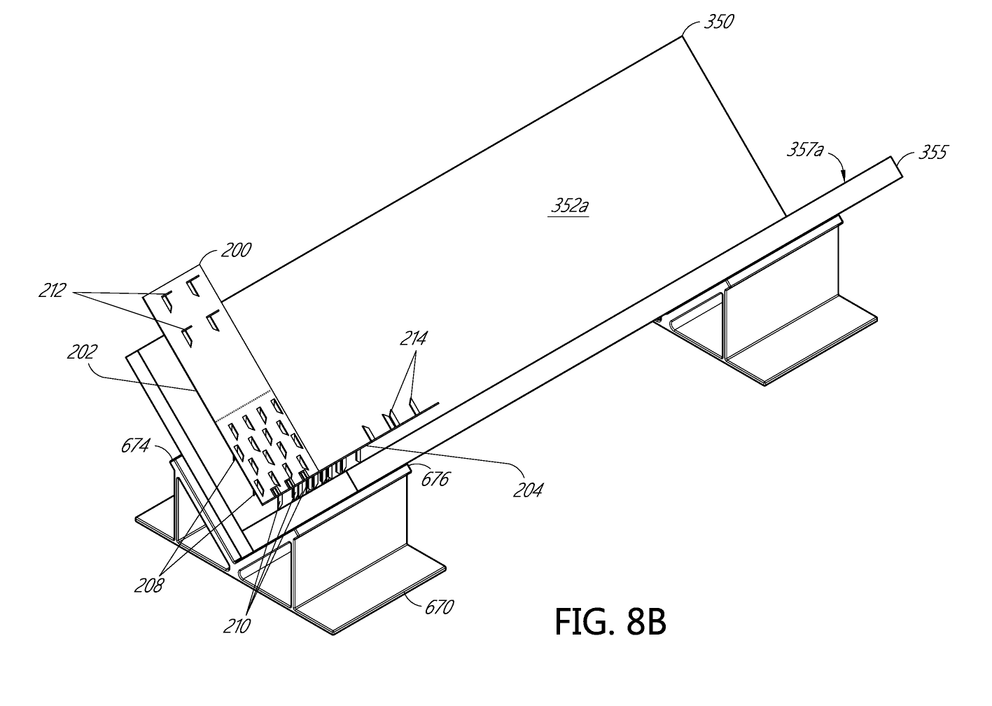

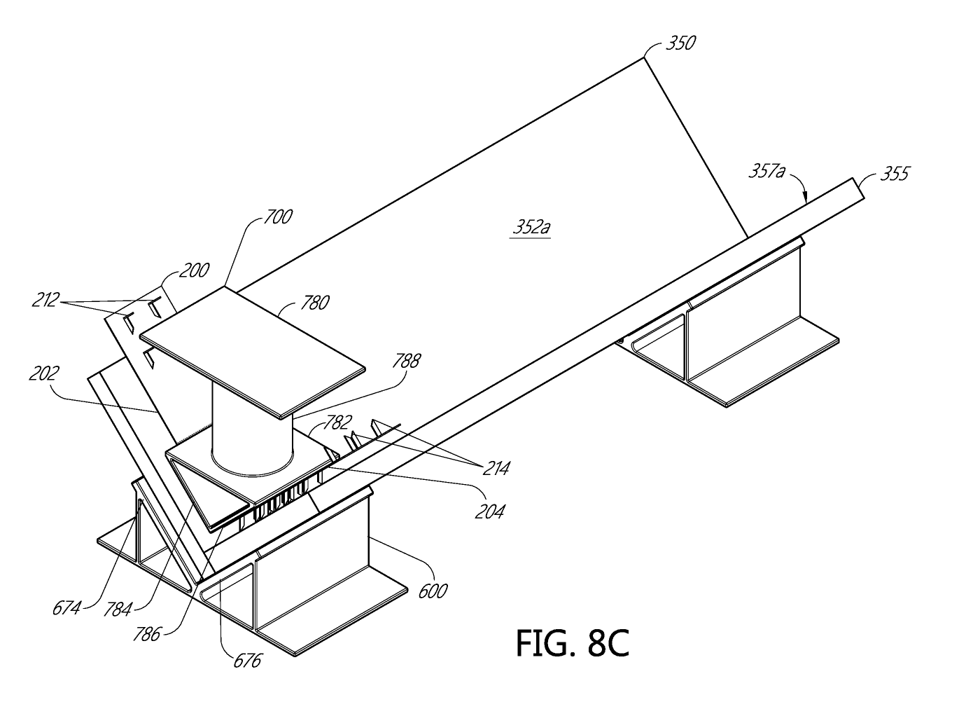

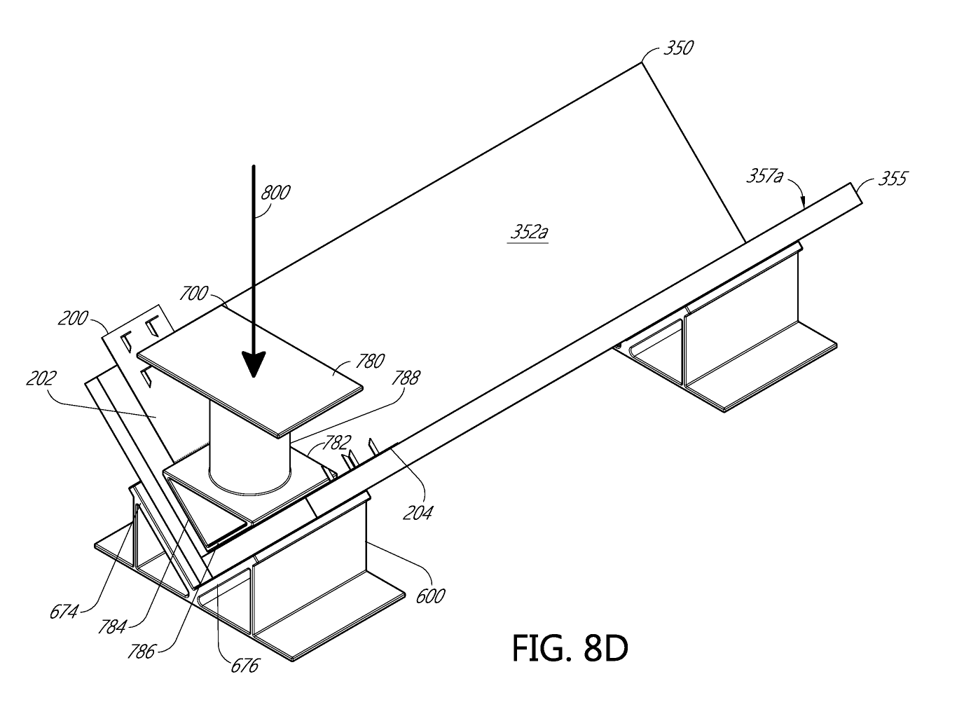

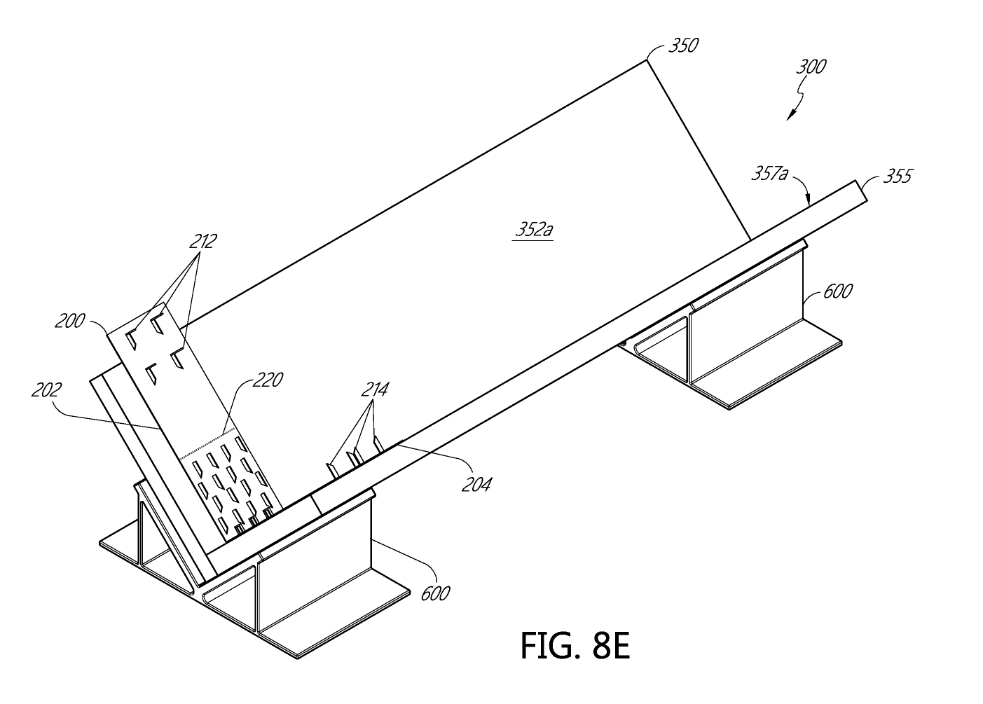

The inner teeth 108, 110 extend from the corresponding arms 102, 104 in line with the bisection of the interior angle of the fastening bracket 100, such that inner teeth 108 are substantially parallel to inner teeth 110. In the example of a 90° fastening bracket 100 shown in FIGS. 1A-1E, the inner teeth 108, 110 extend from the corresponding arms 102, 104 at a 45° angle oriented toward the corner 106 and away from the outer teeth 112, 114. In some embodiments, the angle between the inner teeth 108, 110 and their respective arms 102, 104 can be less than 90°, for example, within a range such as between 40° and 50°, between 43° and 47°, between 44° and 46°, etc. As described in greater detail below with reference to FIGS. 8A-8E, the parallel configuration of the inner teeth 108, 110 may allow the fastening bracket 100 to be coupled to two perpendicular trim boards in a single motion along a direction parallel to the inner teeth 108, 110, simplifying the assembly of a unitary corner trim piece prior to installation.

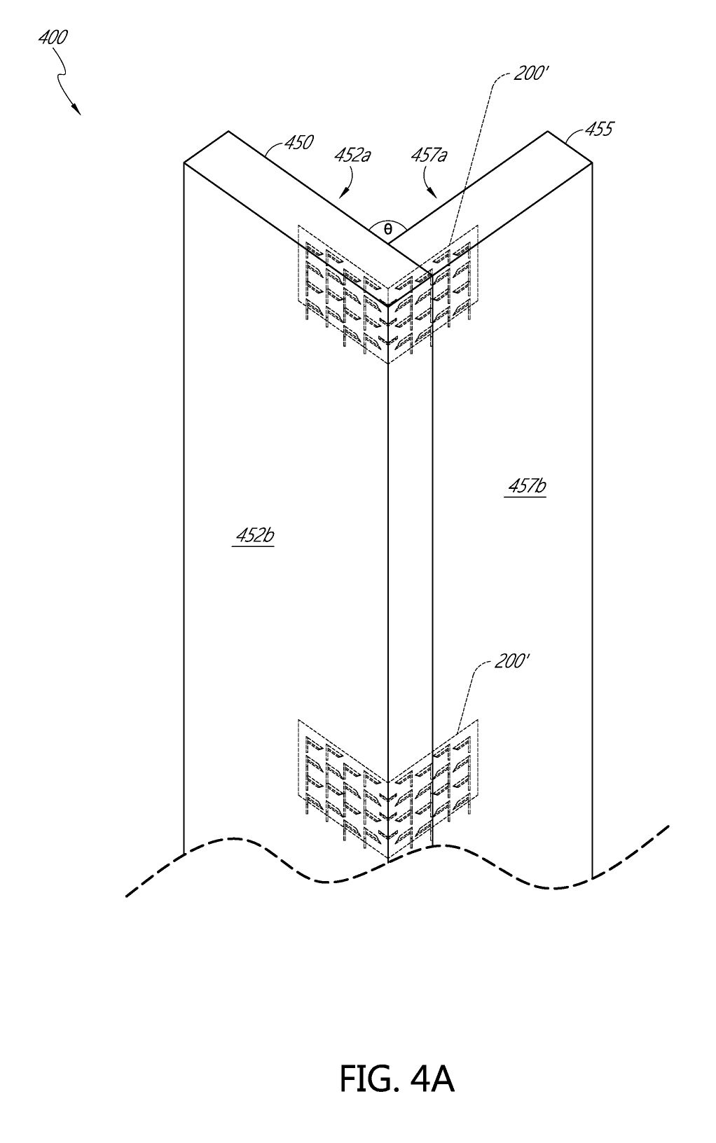

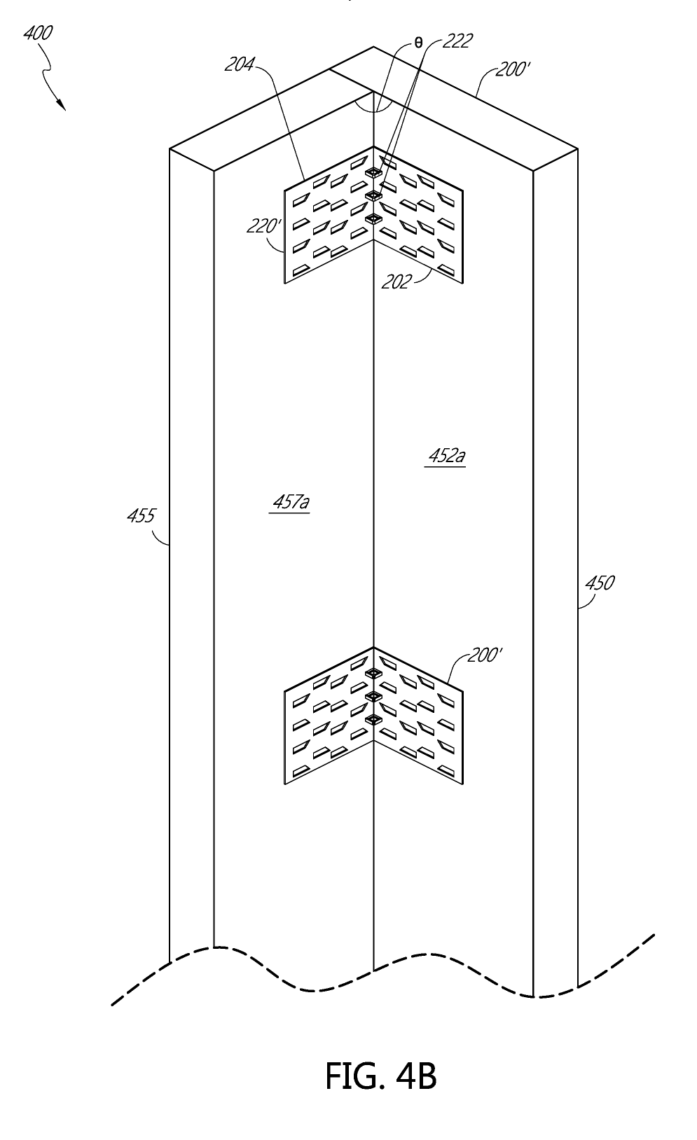

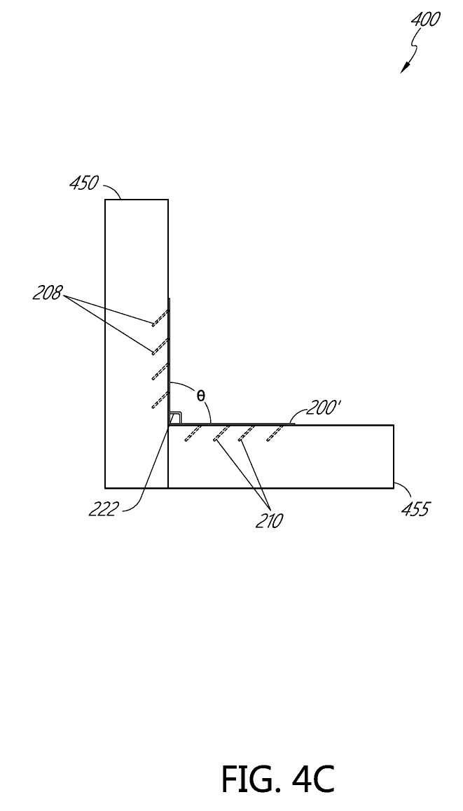

A perforation 120 is disposed across each arm 102, 104. Each perforation 120 may include a generally linear array of recesses extending at least partially through the bracket material. Accordingly, the outer portion of one or both arms 102, 104 may be detached from the medial portion of the fastening bracket 100 between the perforations 120, such as by bending or snapping. In some embodiments, the bracket 100 may be sized such that the arms 102, 104 extend beyond and/or overhang beyond the edges of attached trim boards, and can be snapped off at the perforations 120 such that the remaining medial portion does not overhang the trim boards. The depth and/or spacing of individual recesses of the perforations 120 may be selected such that the outer portions of the arms 102, 104 can be separated from the fastening bracket 100 by a human manually applying a bending force. Application of only the medial portion of a fastening bracket 100 is described in greater detail below with reference to FIGS. 4A-4C.

Although the perforations 120 are depicted as being located between the inner teeth 108, 110 and the outer teeth 112, 114 at a location proximate the inner teeth 108, 110, it will be appreciated that the perforations 120 may be located at any other location along the arms 102, 104 without departing from the spirit or scope of the present disclosure. For example, in some embodiments, the perforations 120 may be located within the medial portion among the inner teeth 108, 110, at another location along the intermediate portion 103, such as near the middle of the medial portion 103 or proximate the outer teeth 112, 114, or at a location among the outer teeth 112, 114. Moreover, one or both arms 102, 104 may have more than one perforation 120. In one example, each arm 102, 104 may include a first perforation at the location shown in FIGS. 1A-1E, a second perforation proximate the outer teeth 112, 114, and/or a third perforation located among the outer teeth 112, 114. A perforation among the outer teeth 112, 114 may be advantageous, for example, in applications in which less than all of the outer teeth 112, 114 are required for mounting to a particular building substrate or with a particular mounting method.

The fastening bracket 100 may be manufactured from a sheet of material (e.g., a metal, a plastic, or the like), such as by roll forming, pressing, punching, or the like, or by a combination of such manufacturing methods. During the manufacturing process, each of the teeth 108, 110, 112, 114 may be created by punching or otherwise cutting and/or bending a portion of the material out of the plane of each arm 102, 104. Thus, each of the inner teeth 108, 110 is disposed adjacent to a corresponding inner tooth aperture 116 created by the punching process. Similarly, each of the outer teeth 112, 114 is disposed adjacent to a corresponding outer tooth aperture 118 created by the punching process. In the example fastening bracket 100 of FIGS. 1A-1E, each inner tooth aperture 116 corresponds to a single one of the inner teeth 108, 110, while each outer tooth aperture 118 corresponds to two of the outer teeth 112, 114. However, either arrangement may be used for both inner teeth 108, 110 and outer teeth 112, 114, depending on the desired size, location, and spacing of the inner teeth 108, 110 and the outer teeth 112, 114.

In some embodiments, the fastening bracket 100 further includes one or more reinforcing bars 122. The reinforcing bars 122 may be created by punching, for example, when the corner 106 is formed. The reinforcing bars 122 span the interior angle of the fastening bracket 100 to maintain a desired spacing between the first arm 102 and the second arm 104. For example, if the fastening bracket 100 comprises a 90° angle, the reinforcing bars 122 may extend from each arm 102, 104 at a 90° angle as shown in FIGS. 1B and 1C, to maintain the 90° interior angle of the fastening bracket 100. In the example embodiment depicted in FIGS. 1A-1E, each side of the reinforcing bars 122 has a length of approximately 0.25 inches, although longer or shorter reinforcing bars 122 may equally be used. In some embodiments, the reinforcing bars 122 may be linear members extending from each arm at a 45° angle. When the fastening bracket 100 is installed about a corner of a building substrate, the reinforcing bars 122 may rest against the exterior of the building substrate or may be driven at least partially into the building substrate.

Referring to FIGS. 1C and 1D, dimensions of the fastening bracket 100, inner teeth 108, 110, and outer teeth 112, 114 will be described. Each arm 102, 104 is defined by a length z and a width w, as shown in FIG. 1D. Both arms 102, 104 may have the same width w and length z, or the arms 102, 104 may have different lengths z and/or widths w. The length z may be determined, for example, based on a width or range of widths of trim boards to be fastened to the fastening bracket 100. For example, the length z may be between 2 inches and 12 inches or longer, between 4 inches and 8 inches, between 5 inches and 7 inches, or other suitable range. In some embodiments, the length z of each arm is approximately 6 inches. The width w may be determined, for example, based on a weight, density, or length of trim boards to be fastened to the fastening bracket 100, and/or based on an intended spacing of fastening brackets 100 along the trim boards. For example, the width w may be between 0.5 inches and 5 inches or longer, between 1 inch and 4 inches, between 1.5 inches and 3 inches, or other suitable range. In some embodiments, the width w of each arm is approximately 2 inches.

The outer teeth 112, 114 are defined by a length x. Similarly, the inner teeth 108, 110 are defined by a lengthy. The outer teeth 112, 114 and inner teeth 108, 110 can further be defined by a width v. In various embodiments, the length y of the inner teeth 108, 110 may be the same as the length x of the outer teeth 112, 114, or the lengths x and y may be different. For example, the lengths x and y may be between 0.2 inches and 1 inch or longer, between 0.3 inches and 0.6 inches, or other suitable range. In some embodiments, the length x of each outer tooth is approximately 0.375 inches, approximately 0.4375 inches, or another suitable length. In some embodiments, the length y of each inner tooth is approximately 0.425 inches. In some embodiments, the length y may be within a range of lengths such as between 0.375 inches and 0.75 inches, or a subrange thereof. Generally, the lengths of the outer teeth 112, 114 and inner teeth 108, 110 may be selected based on the weight or density of trim boards to be installed using the fastening bracket 100, the number of teeth, or other characteristics. For example, in some embodiments the inner teeth 108, 110 may be optimized for fastening to extruded fiber cement trim boards. In this example, the length, width, shape, and/or other aspect of the inner teeth 108, 110 may be selected such that the inner teeth 108, 110 are able to penetrate the fiber cement material, and have a length appropriate for mounting to a grooved rear surface of the trim boards while being short enough to avoid extending near, to, or through the exterior side of the trim boards. The lengths of all of the inner teeth 108, 110 may be consistent, or some of the inner teeth 108, 110 may have different lengths relative to other inner teeth 108, 110. Similarly, the lengths of all of the outer teeth 112, 114 may be consistent, or some of the outer teeth 112, 114 may have different lengths relative to other outer teeth 112, 114.

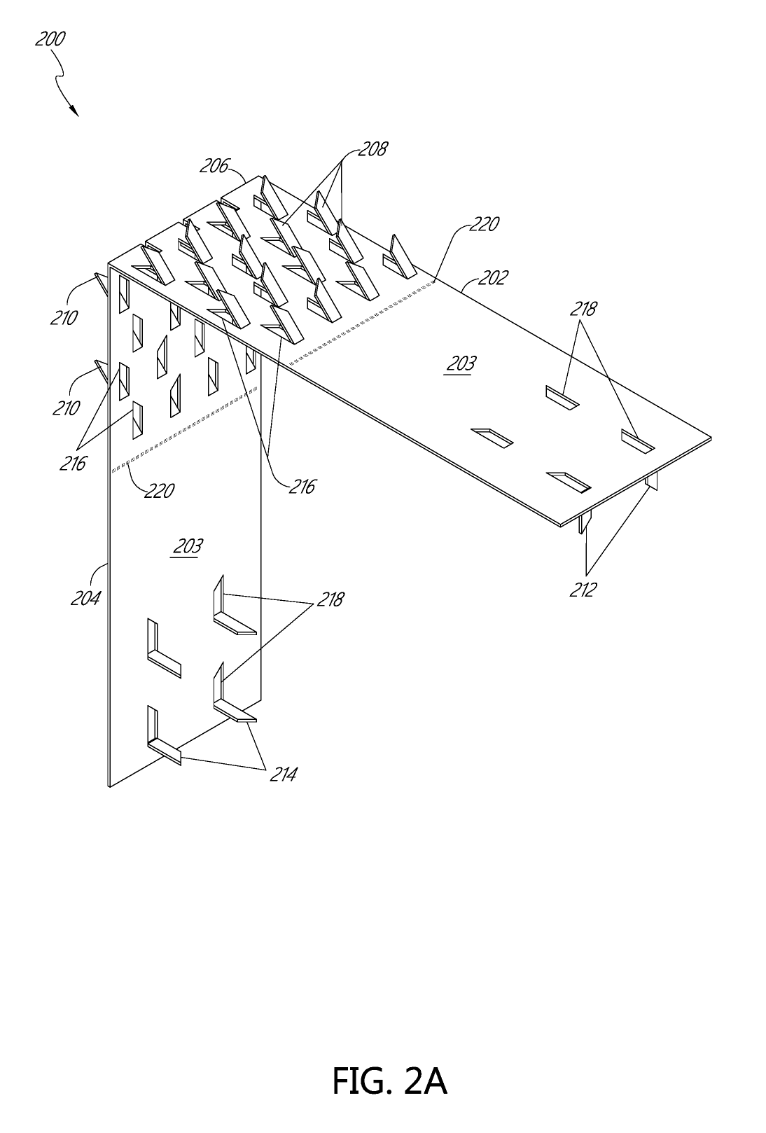

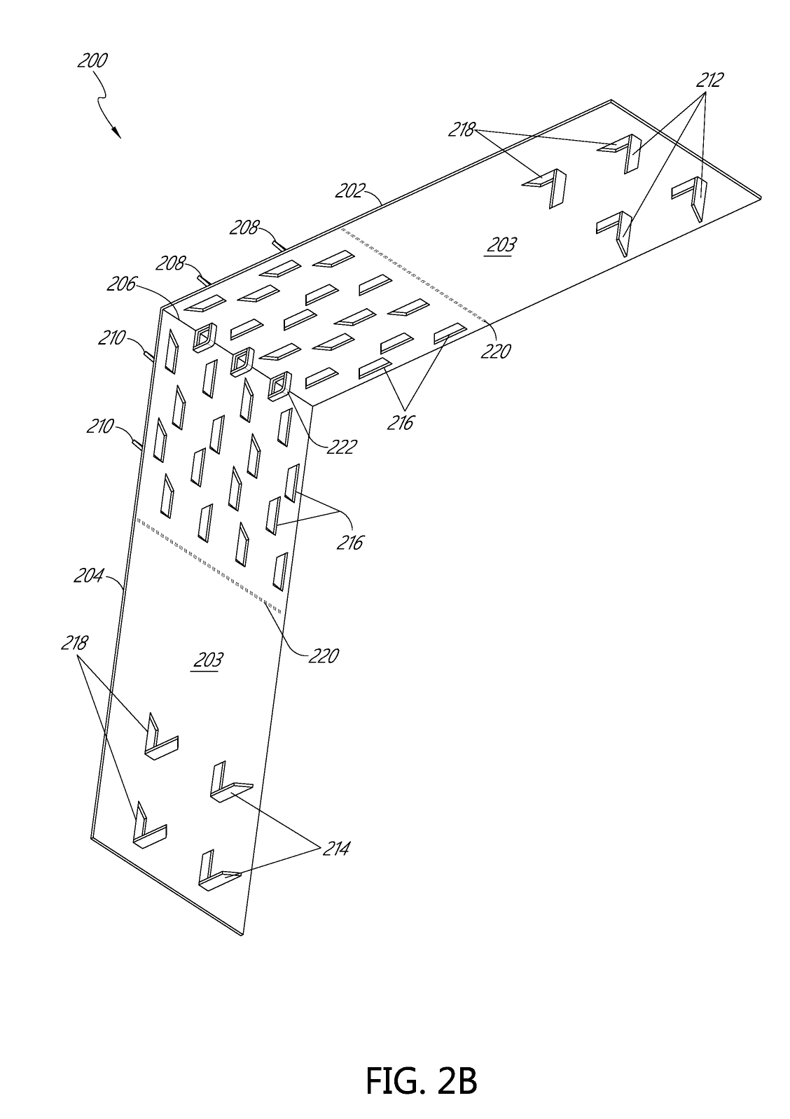

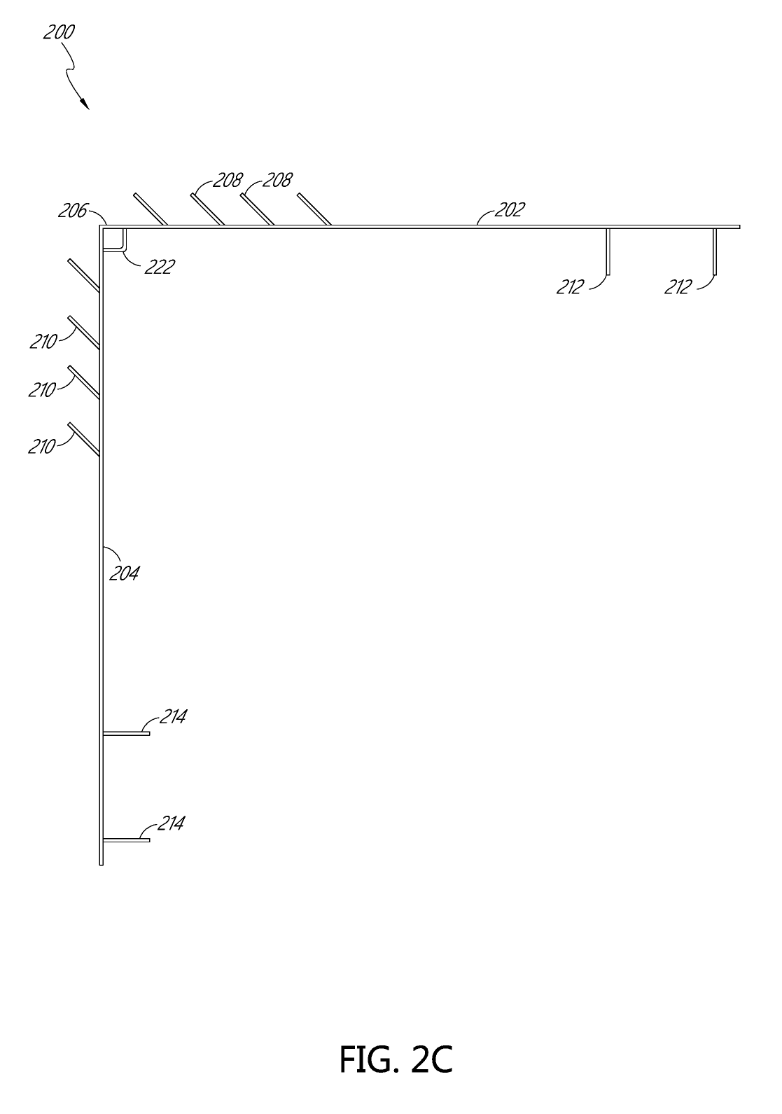

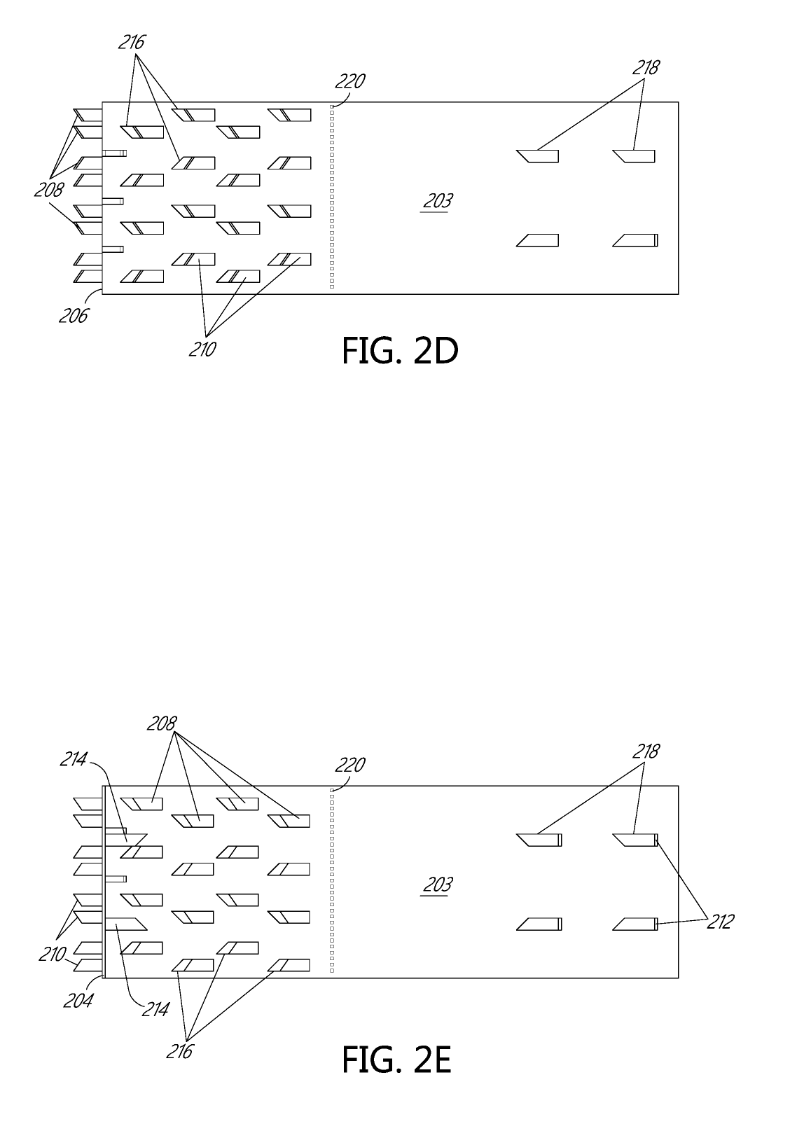

FIGS. 2A-2E depict a further embodiment of a fastening bracket 200. Similar to the fastening bracket 100 depicted in FIGS. 1A-1E, the fastening bracket 200 includes two arms 202, 204 joined at a corner 206. Each arm 202, 204 includes a plurality of inner teeth 208, 210 having an approximate angle of 45° relative to the arm 202, 204, and a plurality of outer teeth 212, 214 having an approximate angle of 90° relative to the arm 202, 204, separated by an intermediate portion 203 and perforations 220.

In the example embodiment of FIGS. 2A-2E, each arm 202, 204 includes 16 inner teeth 208, 210 and 4 outer teeth 212, 214. Compared to the fastening bracket 100 of FIGS. 1A-1E, the fastening bracket 200 has fewer outer teeth 212, 214. In some embodiments, a smaller number of outer teeth 212, 214 may be appropriate where the smaller number of outer teeth 212, 214 still provides sufficient anchoring strength, and may increase the rigidity and/or dimensional stability of the fastening bracket 200 by including fewer outer tooth apertures 218. In embodiments in which greater anchoring strength is desired, the number of outer teeth 212, 214 may be increased, for example, as depicted in FIGS. 1A-1E. However, the punched teeth described and depicted herein can provide substantial dimensional stability to a corner trim such that a relatively small number of outer teeth 212, 214 (e.g., 4 outer teeth 212, 214 on each arm 202, 204) may suffice for many implementations. The number of inner teeth 208, 210 and corresponding inner tooth apertures 216 may similarly be greater or smaller if desired.

Although the illustrated embodiments depict the outer teeth 212, 214 being disposed in parallel rows, it will be appreciated that the outer teeth 212, 214 may equally be arranged in differing orientations. For example, in some embodiments the outer teeth 212, 214 can include four outer teeth 212, 214 disposed in staggered rows or in a cruciform configuration such that the four outer teeth 212, 214 are spaced closely together (e.g., within the area covered by a hammer or other driver, such as within an area of 4 square inches, 2 square inches, etc.), with the associated outer tooth apertures 218 extending radially outward therefrom.

Referring jointly to FIGS. 1A-2E, the fastening brackets 100, 200 described above may comprise a variety of materials. For example, the fastening brackets 100, 200 may comprise metals such as steel (e.g., stainless steel), copper, aluminum, brass, bronze, titanium, or other metals and/or alloys. In some embodiments, the fastening brackets 100, 200 or portions thereof may comprise composite materials, plastics, or other polymeric materials. The fastening brackets 100, 200 may comprise a suitably rigid material to retain dimensional stability of the fastening brackets 100, 200 under the load of supporting one or more trim boards. Malleable materials such as metals may provide sufficient rigidity while being convenient to manufacture by rolling, punching, and the like. Moreover, the inner teeth 108, 110, 208, 210 and outer teeth 112, 114, 212, 214 (and/or some or all of the bracket 100, 200) may comprise suitably rigid material to be drivable into a trim board material such as wood, fiber cement, or the like, such as by hammering. In one example, suitable rigidity may be achieved by manufacturing the brackets 100, 200 from a metal such as a non-hardened steel having a modulus of elasticity of between approximately 28 Mpsi and 30 Mpsi.

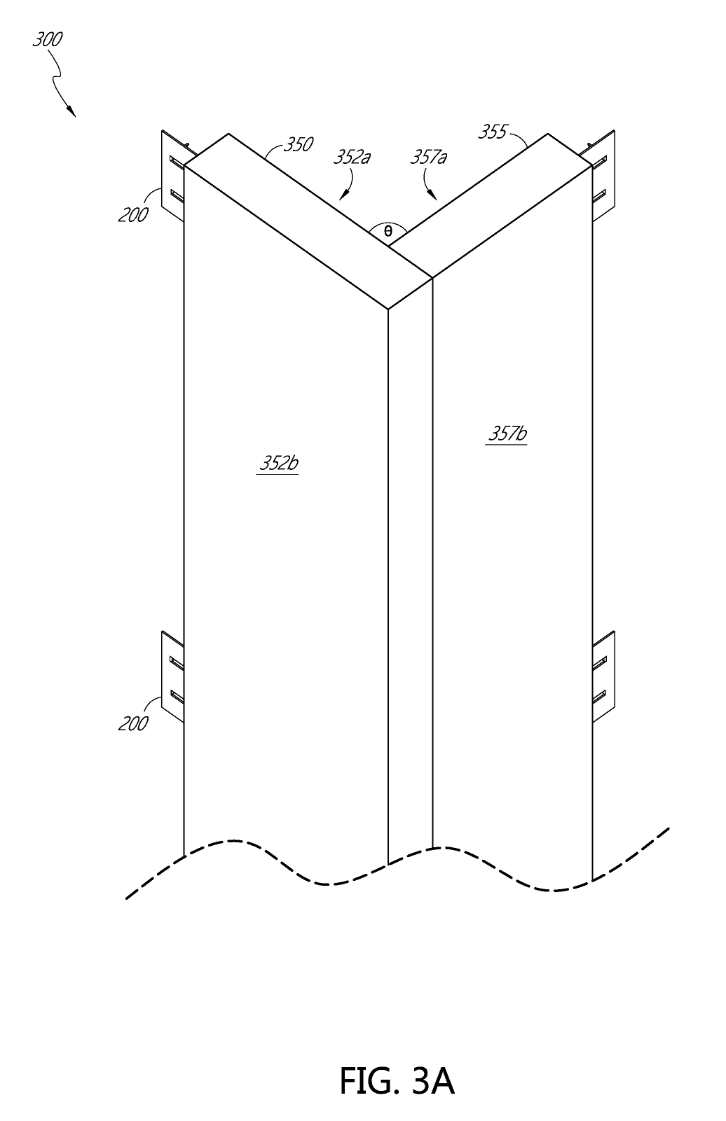

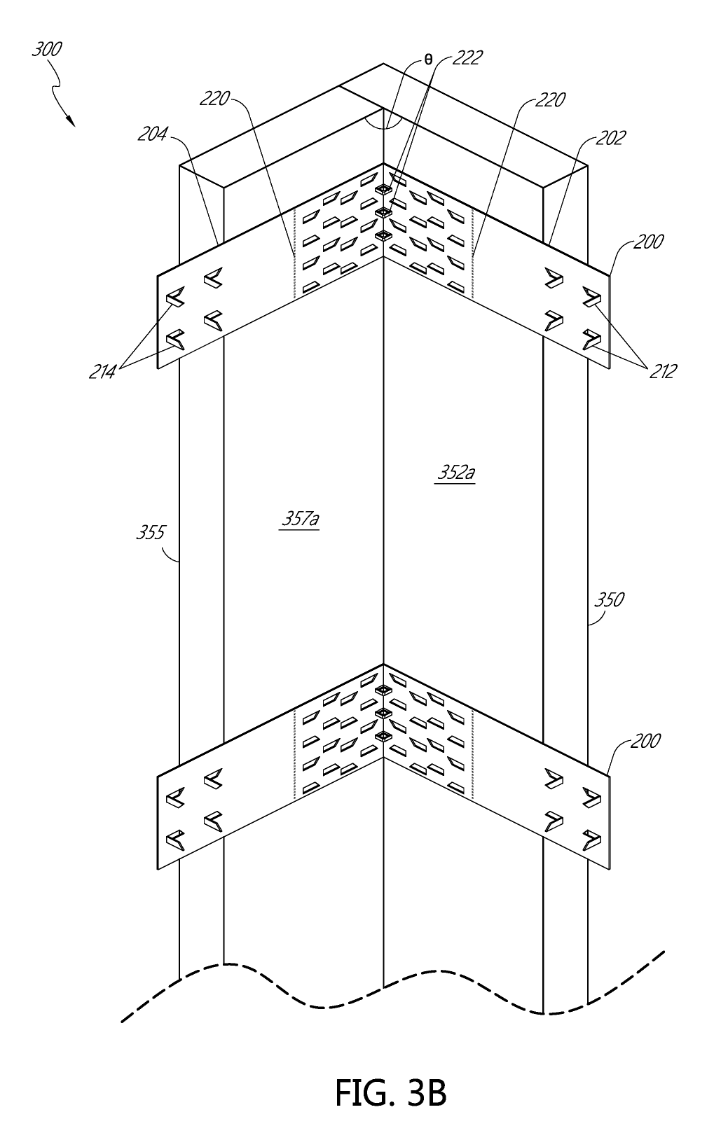

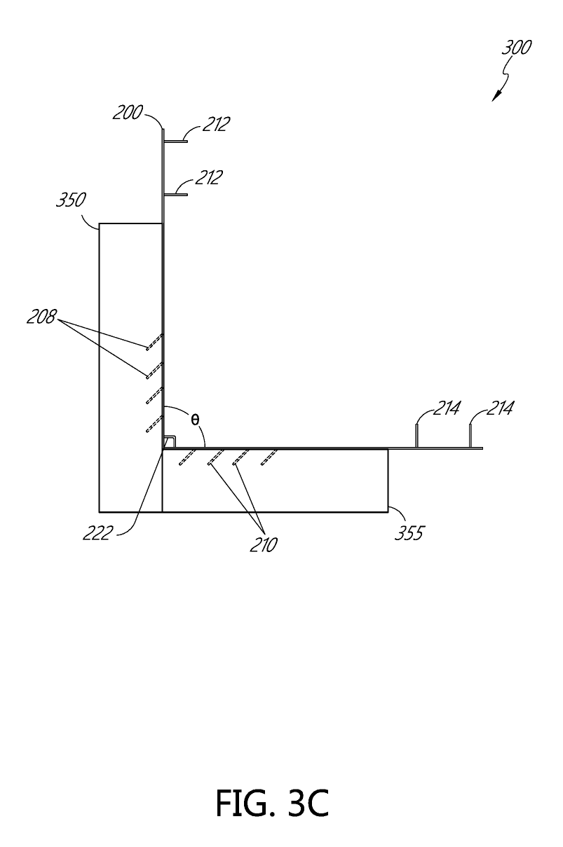

FIGS. 3A-3C depict an assembled corner trim 300 assembled with the fastening brackets 200 described herein. Although fastening brackets 200 are depicted in FIGS. 3A-3C, it will be appreciated that the assembled corner trim 300 may equally be assembled using the brackets 100 depicted in FIGS. 1A-1E and/or using any one or combination of the other fastening bracket embodiments described herein. The trim corner 300 includes a first trim board 350, a second trim board 355, and one or more fastening brackets 200. The first trim board 350 includes an inner face 352a and an outer face 352b. Similarly, the second trim board 355 includes an inner face 357a and an outer face 357b. The trim boards 350, 355 may be any type of boards suitable for interior or exterior trim applications. For example, the trim boards 350, 355 may comprise wood, fiber cement, composites, plastics, polymeric materials, or the like.

As shown in FIGS. 3B and 3C, the inner teeth 208 of the first arm 202 have been driven through the inner face 352a to anchor the fastening bracket 200 to the first board 350 such that the outer surface of the first arm 202 lies flat against the inner face 352a. Similarly, the inner teeth 210 of the second arm 204 have been driven through the inner face 357a to anchor the fastening bracket 200 to the second board 355 such that the outer surface of the second arm 204 lies flat against the inner surface 357a. Thus, when anchored to the boards 350, 355, the fastening bracket 200 retains the boards 350, 355 as a corner trim 300. The fastening bracket 200 maintains the angle θ between the first board 350 and the second board 355. Reinforcing bars 222, if provided, help to maintain a constant angle θ and prevent the corner trim 300 from collapsing inward, opening up, or otherwise deforming.

In the configuration shown in FIGS. 3A-3C, the assembled corner trim 300 is ready to be mounted to a building substrate. In an example mounting process, the corner trim 300 may be placed against a corner of a building substrate such that the corner of the building substrate is disposed within the interior angles of the fastening brackets 200 and the outer teeth 212, 214 abut the surface of the building substrate. The outer teeth 212, 214 may then be driven into the building substrate, such as by hammering or otherwise exerting an inward pressure along a direction parallel to the outer teeth 212, 214, to secure the corner trim 300 to the building substrate. As described above, in some embodiments, one or both arms 202, 204 may be partially separated from the fastening brackets 200 at perforations 220 to form a configuration such as the configuration of FIGS. 4A-4C.

FIGS. 4A-4C depict a further embodiment of an assembled trim corner 400 assembled with medial portions 200′ of example fastening brackets described herein. The trim corner 400 includes a first trim board 450, a second trim board 455, and one or more medial portions 200′. It will be appreciated that the medial portions 200′ may be produced as medial portions 200′ only, or may be formed by removing outer portions of arms 102, 104 or 202, 204 of the fastening brackets 100, 200 depicted in FIGS. 1A-2E. The first trim board 450 includes an inner face 452a and an outer face 452b. Similarly, the second trim board 455 includes an inner face 457a and an outer face 457b. As in the trim corner 300 depicted in FIGS. 3A-3C, the first trim board 450 and the second trim board 455 are fastened together at an angle θ by the inner teeth 208, 210 of the medial portions 200′, with the arms 202, 204 and/or reinforcing bars 222 substantially maintaining the angle θ between the first trim board 450 and the second trim board 455.

The trim corner 400 has been assembled with only the medial portions 200′ of the fastening brackets 100, 200. In one example method, the configuration of the trim corner 400 may have been produced by assembling the trim corner 300 as shown in FIGS. 3A-3C, followed by removing the outer portions of the arms 202, 204 at the perforations 220 (as shown in FIGS. 2A-2E) to leave only the medial portion 200′ of each fastening bracket, bounded by leading edges 220′. In another example method, the outer portions of the arms 202, 204 may have been removed at the perforations 220 (as shown in FIGS. 2A-2E) prior to fastening the medial portions 200′ to the trim boards 450, 455. Because the medial portion 200′ includes all inner teeth 208, 210 and the optional reinforcing bars 222, the medial portions 200′ may be equally as effective as full fastening brackets 100, 200 for maintaining the angle θ between the trim boards 450, 455.

The configuration of the corner trim 400 may be desirable if additional mechanical fasteners, such as nails, screws, or the like, will be used to mount the corner trim 400 to a building substrate. For example, if the corner trim 400 is mounted to a building substrate by mechanical fasteners, the outer teeth 212, 214 as shown in FIGS. 3A-3C may be unnecessary. In addition, removing the outer portions of the arms 202, 204 may make available a greater number of fastening locations along the surfaces of the board 450, 455. For example, a nail may be driven through at lateral portion of the first board 450 or the second board 455 at the same height as one of the medial portions 200′ without being obstructed by a layer of the mounting bracket material. Moreover, some trim installation locations (e.g., building substrate corners) may be located near one or more obstructions such that the corner trim 400 would not fit in the desired location when the entirety of arms 202, 204 are present. Accordingly, the optional configurations depicted in FIGS. 3A-4C may provide a variety of customizable installation options to suit installer or customer preferences, or individual site requirements, building substrate dimensions, etc. Further examples of attachment systems that may be used in conjunction with the configurations of FIGS. 3A-4C are described in U.S. patent application Ser. No. 13/628,254, now issued as U.S. Pat. No. 8,813,444, which is incorporated by reference herein in its entirety.

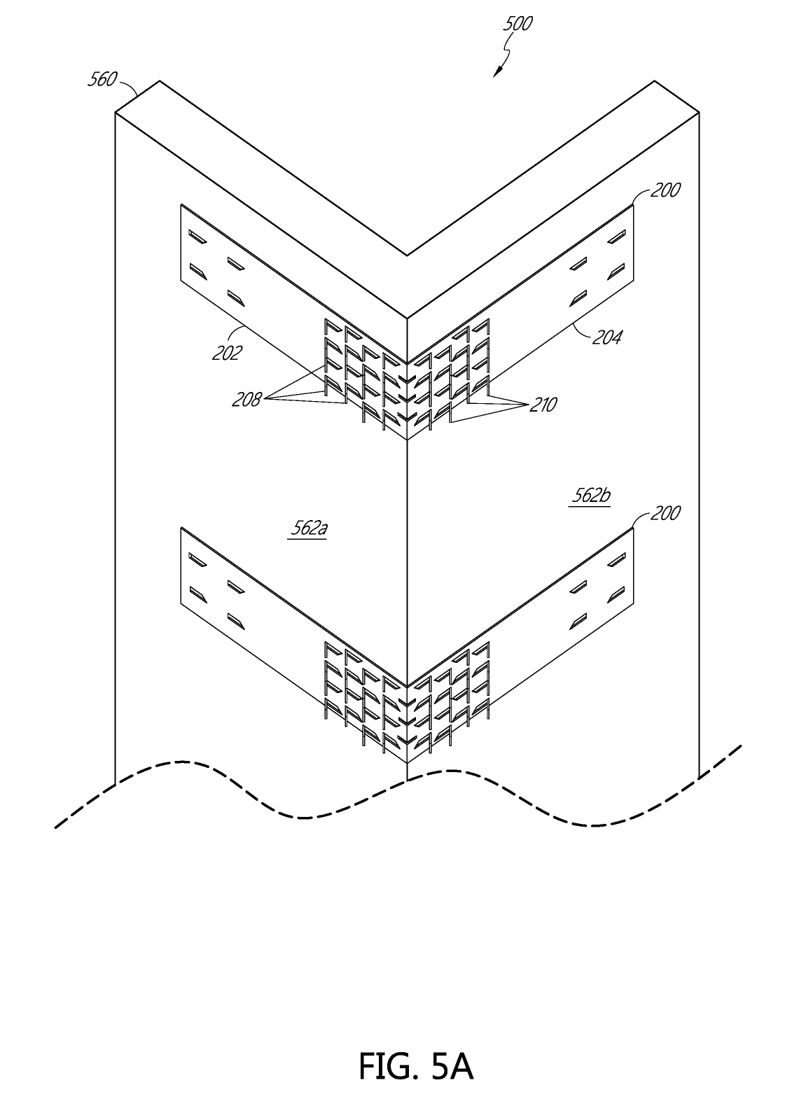

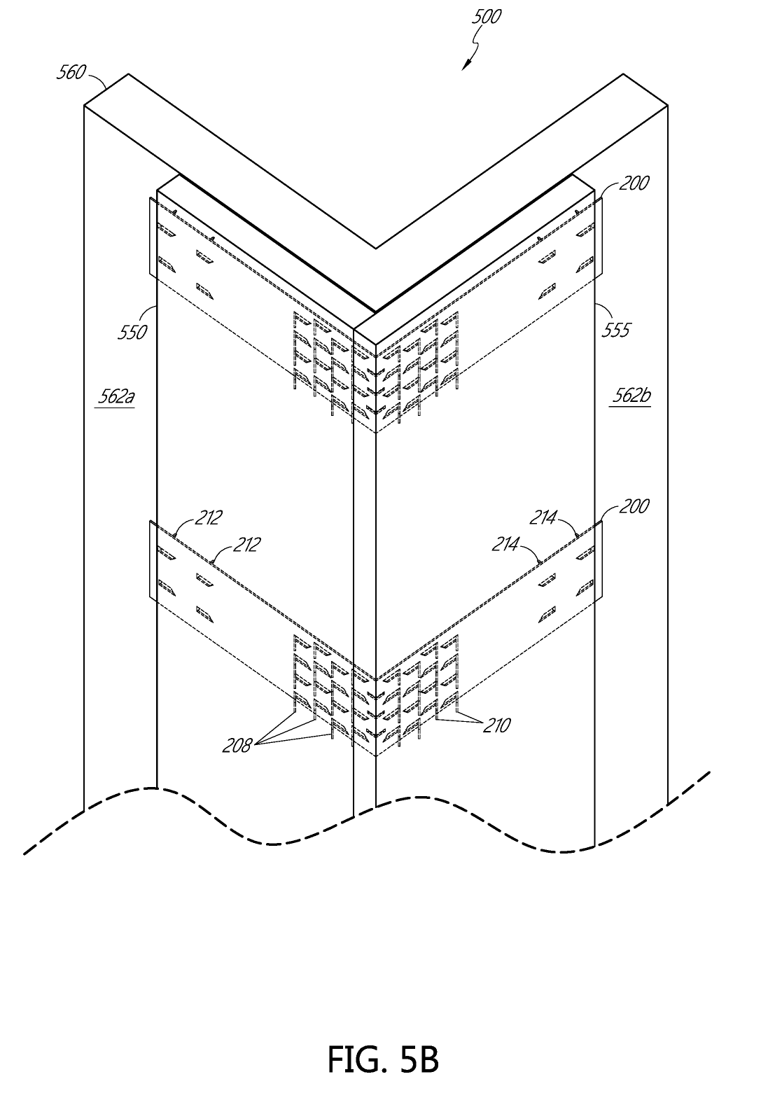

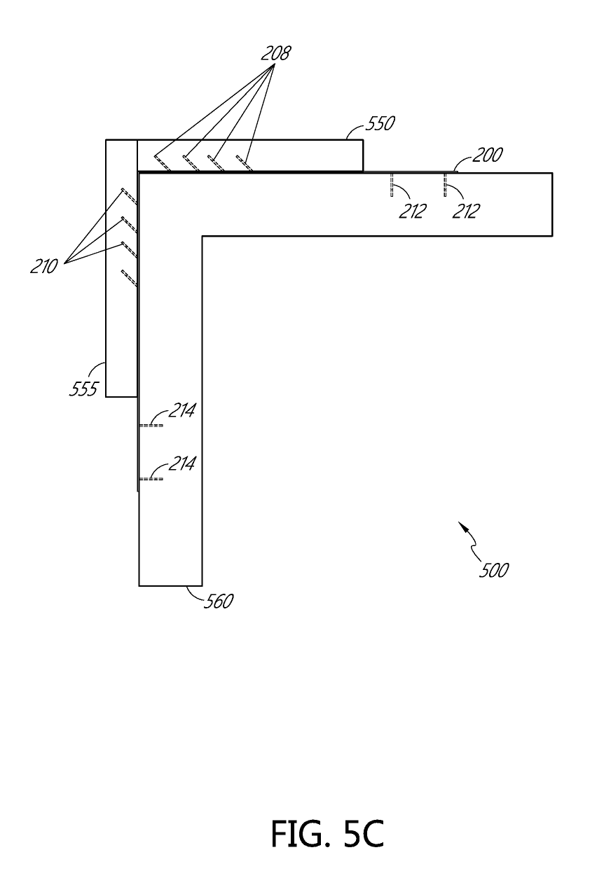

As described above, a corner trim 300, 400 may be assembled and installed before being mounted to a building substrate. Alternatively, a corner trim may be assembled on a building substrate by mounting one or more fastening brackets 100, 200 to a building substrate (e.g., by driving outer teeth 112, 114, 212, 214 into the building substrate on opposite sides of a corner), followed by affixing trim boards to the mounted fastening brackets 100, 200. FIG. 5A depicts a plurality of fastening brackets 200 affixed to an exterior corner 500 of a building substrate 560. The fastening brackets 200 may be affixed by hammering or otherwise driving the outer teeth 212, 214 (illustrated in FIGS. 5B and 5C) into respective first and second perpendicular surfaces 562a, 562b of the building substrate 560. Preferably, the outer teeth 212, 214 can be driven into the building substrate 560 until at least a portion of the first arm 202 lies substantially flat against the first surface 562a of the building substrate 560 and at least a portion of the second arm 204 lies substantially flat against the second surface 562b. With the fastening brackets 200 mounted to the building substrate 560, the inner teeth 208, 210 point outward such that trim boards may be fastened thereto, such as by placing a trim board against the inner teeth 208 or 210 and hammering or otherwise applying pressure to drive the trim board onto the inner teeth 208 or 210.

FIGS. 5B and 5C depict an installed configuration of a corner trim. In the installed configuration of FIGS. 5B and 5C, a first trim board 550 and a second trim board 555 are mounted to the corner 500 of the building substrate 560 to form a corner trim. Fastening brackets 200 are disposed between the building substrate 560 and the trim boards 550, 555. The inner teeth 208 of the first arm 202 extend at least partially into the first trim board 550 and the inner teeth 210 of the second arm 204 extend at least partially into the second trim board 555, such that the fastening brackets 200 are fixed to the first and second trim boards 550, 555. As described above, the outer teeth 212 of the first arm 202 extend at least partially into the first surface 562a and the outer teeth 214 of the second arm 204 extend at least partially into the second surface 562b, such that the fastening brackets 200 are also fixed to the building substrate 560 about the corner 500. Accordingly, the configuration of FIGS. 5B and 5C provides a robust corner trim fixed by the fastening brackets 200 described herein. It will be appreciated that the configuration depicted in FIGS. 5B and 5C can equally be produced as the result of affixing the first and second trim boards 550, 555 to the intermediate configuration of FIG. 5A, or by affixing the assembled corner trim 300 (FIGS. 3A-3C) to the corner 500 of the building substrate 560. Moreover, the installed trim corner depicted in FIGS. 5B and 5C may include any of the variations in components, dimensions, shapes, sizes, assembly methods, fixing means, etc. as described throughout the present disclosure.

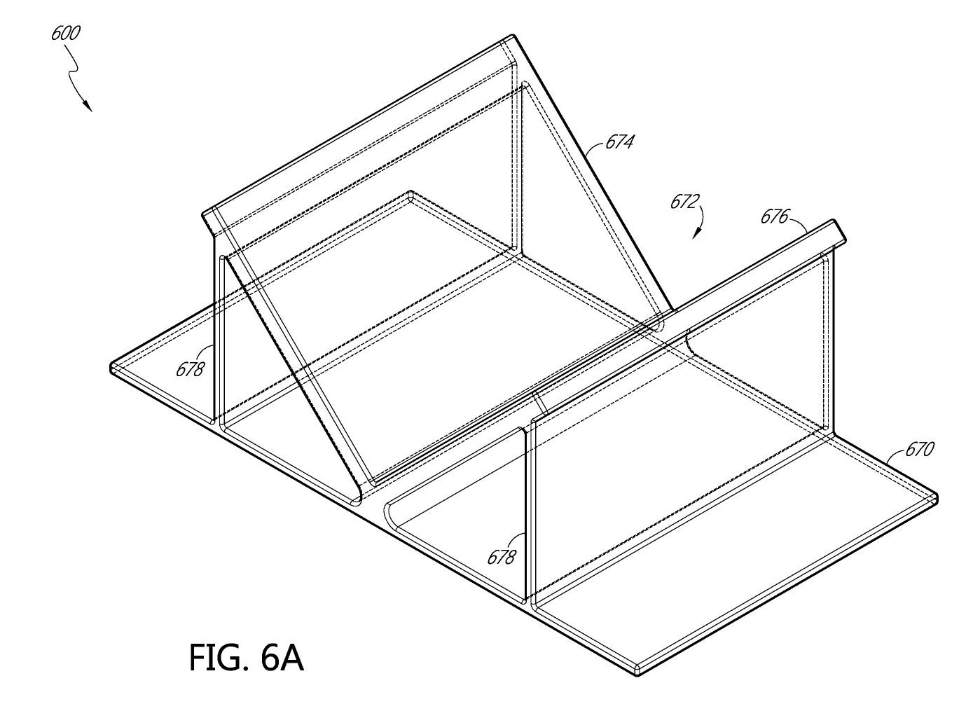

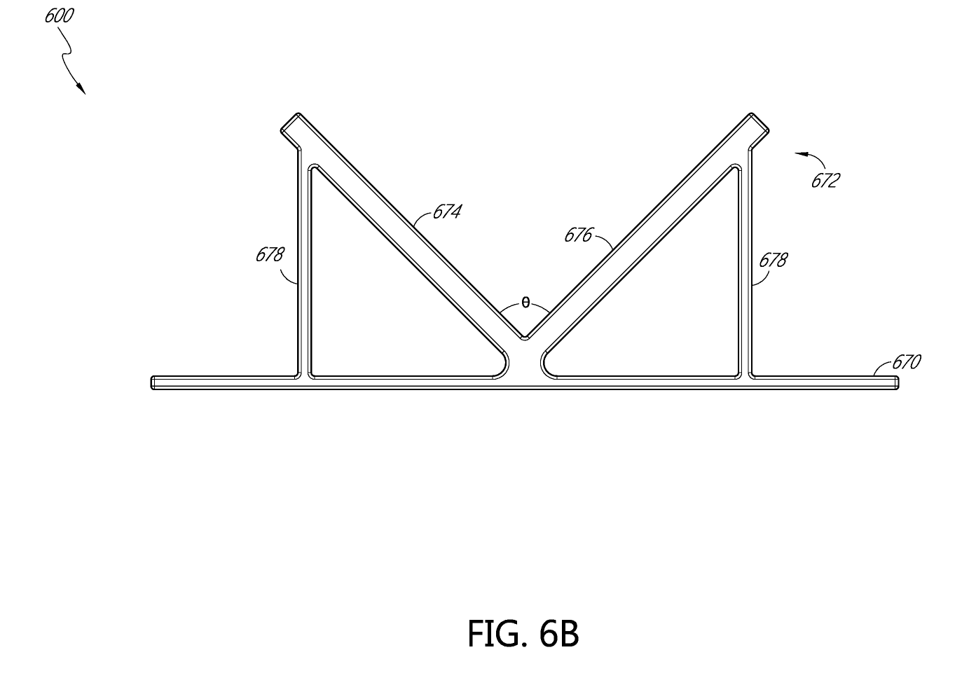

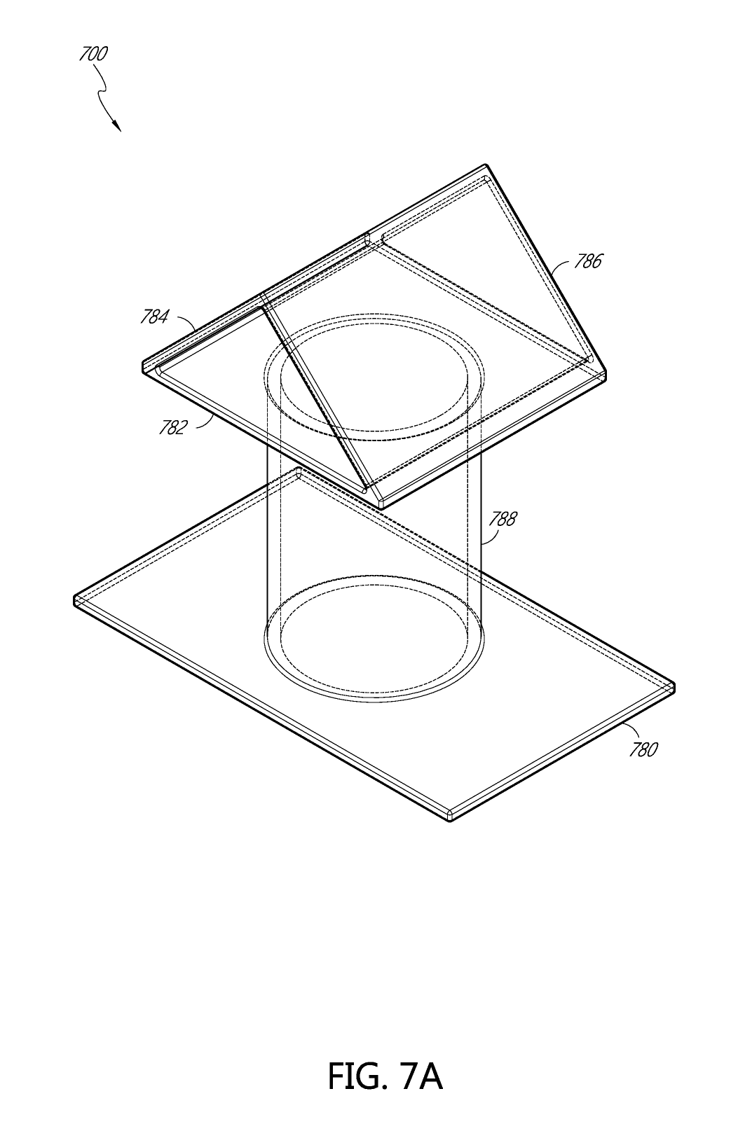

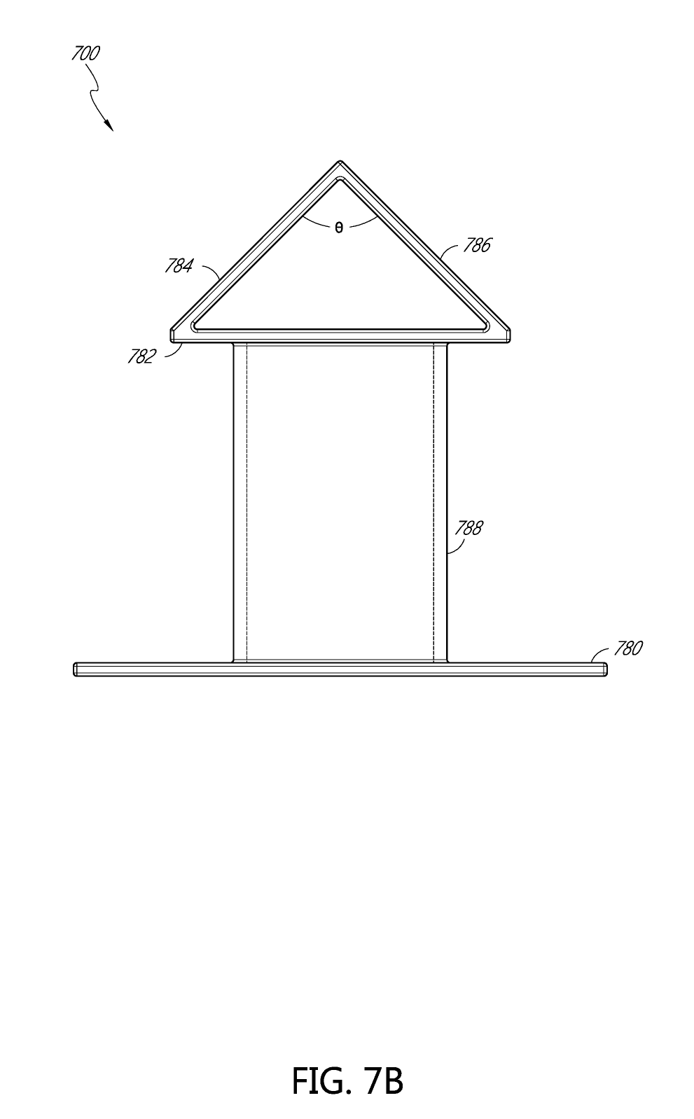

With reference to FIGS. 6A-8E, assembly of corner trim, using trim boards and the fastening brackets 100, 200 described herein, will now be described in greater detail. FIGS. 6A and 6B depict a trim support 600 of a pressing assembly for assembling corner trim. FIGS. 7A and 7B depict a bracket driver 700 of the pressing assembly for assembling corner trim. Together, one or more trim supports 600 and one or more bracket drivers 700 comprise a pressing assembly. FIGS. 8A-8E depict an example process of assembling a corner trim using an example pressing assembly.

Referring to FIGS. 6A and 6B, the trim support 600 includes a base 670 and a trough 672. The trough 672 comprises a first trough surface 674 and a second trough surface 676 forming a substantially V-shaped trough. The trough surfaces 674, 676 are rigidly supported and retained at an interior angle θ by trough supports 678. The interior angle θ is equal to the desired relative angle θ (as used elsewhere herein) between the trim boards of corner trims to be assembled using the pressing assembly. In a trim support 600 for assembling the corner trims 300, 400 described herein, the angle θ would be approximately 90°. In some embodiments, the angle θ may be other than 90°, and/or may be adjustable such that the angle can be changed as desired, for example, by an installer. As will be described in greater detail with reference to FIGS. 8A-8E, the trough surfaces 674, 676 are configured to support trim boards being assembled into a corner trim. The trim support 600 may comprise a suitably rigid material, such as a metal, a plastic or other polymeric material, wood, etc.

Referring to FIGS. 7A and 7B, the bracket driver 700 includes a base 780 and a pressing head 782 rigidly and spacedly coupled to the base 780 by a shaft 788. The pressing head 782 comprises a first pressing surface 784 and a second pressing surface 786. The first and second pressing surfaces 784, 786 intersect at the same angle θ equal or substantially equal to the interior angle θ of the trough 672 of the trim support 600, such that the pressing head 782 can seat within the interior angle of the fastening brackets 100, 200 and/or medial portion 200′ depicted and described herein. In a bracket driver 700 for assembling the corner trims 300, 400 (FIGS. 3A-4C), the angle θ would be approximately 90°. In some embodiments, the intersection between the first and second pressing surfaces 784, 786 includes one or more recesses sized and shaped to accommodate the reinforcing bars 122, 222 depicted in FIGS. 1A-2E. As will be described in greater detail with reference to FIGS. 8A-8E, the pressing surface 784, 786 are configured to seat within a fastening bracket and uniformly distribute a driving or pressing force over at least a portion of the fastening bracket to drive the fastening bracket into trim boards supported by a trim support 600 (FIGS. 7A and 7B).

Referring now to FIGS. 8A-8E, an example process of assembling a corner trim using the pressing assembly of FIGS. 6A-7B will be described. Although the corner trim components are described with reference to the embodiments depicted in FIGS. 2A-3C, it will be appreciated that the pressing assembly and process described may equally be applied with any of the embodiments described herein.

The process begins in the configuration depicted in FIG. 8A, in which a first trim board 350 and a second trim board 355 have been placed onto one or more trim supports 600. The outer face 352b of the first trim board 350 rests on the first trough surface 674 such that the inner face 352a faces generally upward and/or outward. Similarly, the outer face 357b of the second trim board 355 rests on the second trough surface 676 such that the inner face 357a faces generally upward and/or outward. The inner faces 352a and 357a are disposed at the desired angle θ (FIGS. 6A-7B) relative to each other. The bases 670 of the trim supports 600 support the trim supports 600 and trim boards 350, 355 in a stable configuration on a work surface such as a floor or platform. Thus, the trim support 600 supports the trim boards 350, 355 in substantially the configuration to be maintained in the assembled state shown in FIGS. 3A-3C. In the configuration of FIG. 8A, the trim boards 350, 355 are ready to be coupled to a fastening bracket 100, 200 to form an assembled corner trim.

The process continues to the configuration depicted in FIG. 8B, in which at least one fastening bracket 200 has been placed into the trough formed by the inner faces 352a, 357a of the trim boards 350, 355. The inner teeth 208 of the first arm 202 of the fastening bracket 200 rest against the inner face 352a of the first trim board 350, and the inner teeth 210 of the second arm 204 rest against the inner face 357a of the second trim board 355, such that the planar portions of the arms 202, 204 are suspended above the inner faces 352a, 357a of the trim boards 350, 355. Thus, the inner angles of the fastening bracket 200, the trim boards 350, 355, and the trim support 600 are all aligned along a vertical axis bisecting the inner angles. The inner teeth 208 and 210 are substantially parallel, pointing downward and aligned parallel to the vertical axis. Accordingly, each of the inner teeth 208 and 210 is able to penetrate the trim boards 350, 355 by traveling along a single axis parallel to the vertical axis, rather than shifting in multiple axes which may cause deformation, failure to penetrate the trim board 350, 355, or other complication. Although a fastening bracket 200 may be coupled to the trim boards 350, 355 at any point along the length of the trim boards 350, 355, it may be advantageous to position the fastening bracket 200 above one of the trim supports 600 to prevent shifting of the trim boards 350, 355 when the fastening bracket 200 is coupled. In the configuration of FIG. 8B, the fastening bracket 200 is ready to be driven or pressed into the trim boards 350, 355 to form a corner trim.

The process continues to the configuration depicted in FIG. 8C, in which a bracket driver 700 is placed onto the fastening bracket 200. The bracket driver 700 is placed in an inverted orientation such that the base 780 of the bracket driver 700 is disposed above the pressing head 782. The pressing head 782 rests within the interior angle of the fastening bracket 700, such that the first pressing surface 784 rests substantially flat against the first arm 202 opposite the inner teeth 208, and the second pressing surface 786 rests substantially flat against the second arm 204 opposite the inner teeth 210. As illustrated in FIG. 8C, the pressing surfaces 784, 786 of the pressing head 782 may be sized and shaped such that the pressing head 782 fits between the outer teeth 212, 214 and does not impinge on the outer portions of the arms 202, 204 containing the outer teeth 212, 214.

The process continues to the configuration depicted in FIG. 8D, in which the bracket driver 700 is driven downward to complete the corner trim assembly. A force is applied to the base 780 of the bracket driver 700 along a downward direction 800. The direction 800 is substantially parallel to the inner axis along the inner teeth 208, 210 of the fastening bracket 200. Thus, the force applied to the bracket driver 700 both causes the inner teeth 208 of the first arm 202 to be driven into the inner surface 352a of the first trim board 350, and causes the inner teeth 210 of the second arm 204 to be driven into the inner surface 357a of the second trim board 355, in a single smooth pressing motion. In various embodiments, the downward force may be applied to the bracket driver 700 by manual pressure, hammering, and/or any type of pressing or striking mechanism, such as a machine press, forming press, or the like.

After the fastening bracket 200 has been driven into the trim boards 350, 355, the bracket driver 700 may be removed, as shown in FIG. 8E, leaving an assembled or partially assembled corner trim 300 resting on the trim supports 600. The process depicted in FIGS. 8A-8E may be repeated as desired to drive additional fastening brackets 200 into the corner trim 300 and/or to assemble additional corner trim pieces.

In some embodiments, a plurality of fastening brackets 200 may be coupled to the trim boards 350, 355 sequentially or simultaneously. In the example manufacturing setup of FIGS. 8A-8E, a second fastening bracket 200 can be placed onto the trim boards 350, 355 such that a fastening bracket 200 is disposed over each trim support 600. A second bracket driver 700 may be placed atop the second fastening bracket 200, and driven downward in a similar fashion at the same time or subsequently. For example, a machine press may exert a downward pressure onto both bracket drivers 700 simultaneously such that both fastening brackets 200 are driven simultaneously into the trim boards 350, 355. In various embodiments, any number of fastening brackets 200 may be driven simultaneously into the trim boards 350, 355, for example, 2, 3, 4, 5, 6, 8, or more fastening brackets 200 (e.g., depending on the desired number of fastening brackets, availability of trim supports 600 and bracket drivers 700, etc.).

Various advantages may be achieved by manufacturing corner trims 300 using the process described above with reference to FIGS. 8A-8E. In some embodiments, the trim supports 600 and bracket drivers 700 are preconfigured with an angle θ (FIGS. 6A-7B) substantially equal to the interior angle of the fastening brackets 200 such that all components seat together smoothly as shown in FIG. 8C. In some embodiments, the substantially identical angles of the pressing head 782 and the fastening bracket 200 may allow the pressing surfaces 784, 786 to exert a substantially uniform downward pressure along at least the portion of the arms 202, 204 containing the inner teeth 208, 210. Accordingly, the inner teeth 208, 210 can be driven uniformly into the trim boards 350, 355 such that the desired angle between the trim boards 350, 355 is maintained. Moreover, the dimensions of the pressing surfaces 784, 786 may be selected such that they generally cover the portions of the arms 202, 204 containing the inner teeth 208, 210, but do not extend far enough to reach the outer portions of the arms 202, 204 containing the outer teeth 212, 214. Accordingly, the bracket driver 700 may be used to assemble the corner trim 300 without interfering with the outer teeth 212, 214.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Although making and using various embodiments are discussed in detail below, it should be appreciated that the description provides many inventive concepts that may be embodied in a wide variety of contexts. The specific aspects and embodiments discussed herein are merely illustrative of ways to make and use the systems and methods disclosed herein and do not limit the scope of the disclosure. The systems and methods described herein may be used for treatment of process water from cementitious and/or fiber cement building articles and are described herein with reference to this application. However, it will be appreciated that the disclosure is not limited to this particular field of use.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A corner trim system comprising:
a building substrate comprising a first side and a second side disposed at an angle to the first side at an exterior corner;
a corner trim fastening bracket comprising:
a substantially planar first arm having a first end and a second end, the first arm comprising an inner portion proximate the first end and an outer portion proximate the second end, the first arm lying adjacent to the building substrate such that the first end is proximate the exterior corner; and
a substantially planar second arm having a first end and a second end, the second arm comprising an inner portion proximate the first end and an outer portion proximate the second end, the first end of the second arm being integrally formed with the first end of the first arm such that the second arm lies adjacent to the building substrate;
wherein the first arm and the second arm each comprise:
a plurality of outer teeth extending from the outer portion into the building substrate at an angle greater than or equal to 85° relative to the building substrate; and
a plurality of inner teeth extending from the inner portion opposite the building substrate and toward the first end at an angle between 40° and 50° relative to the surface of the inner portion;
a first trim board comprising an inner surface, wherein the inner teeth of the first arm extend through the inner surface to retain the first trim board parallel to the first side of the building substrate; and
a second trim board comprising an inner surface, wherein the inner teeth of the second arm extend through the inner surface to retain the second trim board parallel to the second side of the building substrate.

2. The corner trim system of claim 1, wherein a plurality of vertically spaced corner trim fastening brackets are disposed between the building substrate and the first and second trim boards to retain the first and second trim boards to the building substrate.

3. The corner trim system of claim 1, wherein the inner teeth have a length of approximately 0.375 inches, wherein the inner teeth are disposed in a plurality of rows spaced apart by approximately 0.5 inches, and wherein the density of the inner teeth is at least 4.8 teeth per square inch.

4. The corner trim system of claim 1, wherein the corner trim fastening bracket comprises steel.

5. The corner trim system of claim 1, wherein the first trim board and the second trim board comprise fiber cement.

6. A corner trim fastening bracket comprising:
a substantially planar first arm having a first end and a second end, the first arm comprising an inner portion proximate the first end and an outer portion proximate the second end; and
a substantially planar second arm having a first end and a second end, the second arm comprising an inner portion proximate the first end and an outer portion proximate the second end, the first end of the second arm being integrally formed with the first end of the first arm such that the second arm extends perpendicularly from the first arm within a plane perpendicular to the first arm;
wherein the first arm and the second arm each comprise:
a plurality of outer teeth extending from the outer portion into a space generally defined by an interior angle between the first arm and the second arm, the outer teeth disposed at an angle greater than or equal to 85° relative to the surface of the outer portion, the outer teeth configured to be driven into a building substrate to couple the corner trim fastening bracket to the building substrate; and
a plurality of inner teeth extending from the inner portion into a space opposite the interior angle, the plurality of inner teeth extending toward the first end at an angle smaller than 90° relative to the surface of the inner portion, the inner teeth configured to be driven into a trim board to couple the corner trim fastening bracket to the trim board; and
wherein the inner teeth of the first arm are substantially parallel to the inner teeth of the second arm such that the corner trim fastening bracket can be simultaneously coupled to two substantially perpendicular trim boards by exerting a linear force on the corner trim fastening bracket parallel to the inner teeth.

7. The corner trim fastening bracket of claim 6, wherein the inner teeth of the first arm and the inner teeth of the second arm lie parallel to a bisection of the interior angle between the first arm and the second arm.

8. The corner trim fastening bracket of claim 6, wherein the first arm and the second arm each comprise a widthwise perforation configured to enable at least the outer portion to be separated from the corner trim fastening bracket.

9. The corner trim fastening bracket of claim 8, wherein the first arm and the second arm each comprise a plurality of widthwise perforations.

10. The corner trim fastening bracket of claim 6, wherein the first arm and the second arm each comprise a widthwise perforation configured to enable separation of a portion of the arm comprising less than all of the outer teeth.

11. The corner trim fastening bracket of claim 6, wherein the first arm and the second arm comprise steel.

12. The corner trim fastening bracket of claim 6, wherein the first arm and the second arm each comprise at least 4 outer teeth.

13. The corner trim fastening bracket of claim 6, wherein the first arm and the second arm each comprise at least 8 inner teeth.

14. The corner trim fastening bracket of claim 6, wherein the first arm and the second arm each have a width between 1 inch and 3 inches, and a length between 5 inches and 7 inches.

15. The corner trim fastening bracket of claim 6, wherein each of the inner teeth and the outer teeth has a length between 0.3 inches and 0.6 inches.

16. The corner trim fastening bracket of claim 6, further comprising a reinforcing structure coupled to the first arm and the second arm within the interior angle and configured to prevent deformation of the corner trim fastening bracket.

17. The corner trim fastening bracket of claim 6, wherein each inner tooth of the plurality of inner teeth extends from the first arm or the second arm adjacent to a corresponding inner tooth aperture having a size and shape substantially the same as a size and shape of the inner tooth.

18. The corner trim fastening bracket of claim 6, wherein each outer tooth of the plurality of outer teeth extends from the first arm or the second arm adjacent to a corresponding outer tooth aperture having a size and shape substantially the same as a size and shape of the outer tooth.

19. A corner trim assembly system comprising:
a trim support comprising a trough generally defined by a first trough surface and a second trough surface disposed at an angle to the first trough surface at an interior corner, the trough configured to at least partially support a first trim board and a second trim board disposed relative to the first trim board at an angle substantially equal to the angle of the interior corner; and
a bracket driver comprising:
a pressing head generally defined by a first pressing surface and a second pressing surface disposed at an angle to the first pressing surface at an exterior corner, wherein the angle of the exterior corner is substantially equal to the angle of the interior corner of the trough; and
a force receiving surface rigidly coupled to the pressing head, at least a portion of the force receiving surface comprising a planar surface perpendicular to an axis bisecting the angle of the exterior corner;
wherein the bracket driver is configured to seat within a fastening bracket comprising two arms disposed at an angle substantially equal to the angle of the exterior corner, and
wherein the bracket driver is configured to substantially uniformly distribute, across the first pressing surface and the second pressing surface, a linear force applied to the force receiving surface.

20. The corner trim assembly system of claim 19, wherein the exterior corner of the pressing head comprises a recess sized and shaped to accommodate a reinforcing bar of the fastening bracket.
